(19) United States
(12) Patent Application Publication
(10) Pub. No.: US 2008/0082969 A1
(43) Pub. Date: Apr. 3, 2008

(54) Software Testing Technique Supporting Dynamic Data Structures

(75) Inventors: Gul Agha, Champaign, IL (US); Darko Marinov, Champaign, IL (US); Koushik Sen, Kensington, CA (US)

Correspondence Address: SADLER, BREEN, MORASCH & COLBY, P.S., 422 W. RIVERSIDE AVE., SUITE 424, SPOKANE, WA, 99201, US

(73) Assignee: The Board of Trustees of the University of Illinois, Urbana, IL (US)

(21) Appl. No.: 11/695,995

(22) Filed: Apr. 3, 2007

Related U.S. Application Data
(60) Provisional application No. 60/744,235, filed on Apr. 4, 2006.

(51) Int. Cl. G06F 9/44

(52) U.S. Cl. 717/130

(57) ABSTRACT

The present software testing technique successfully tests software programs that have dynamic data structures and that use pointer operations. The technique iteratively executes the software program using concrete execution and symbolic execution, simultaneously. The concrete execution is driven by inputs generated based on a logical input map, which is updated during symbolic execution. The logical input map represents the inputs using finite memory graphs and scalar symbolic variables.

### RELATED APPLICATIONS

This application claims priority under 35 U.S.C. §119(e) to U.S. Provisional Application No. 60/744,235 filed Apr. 4, 2006.

### GOVERNMENT LICENSE RIGHTS

This invention was made with Government support under Grant Number N00014-02-1-0715 awarded by the Office of Naval Research (ONR). The Government has certain rights in the invention.

### BACKGROUND

Software programs have many functions. Each function typically has one or more conditional statements (e.g., if-then-else). Thus, each function can be traversed during execution in a number of ways depending on which branch (e.g., if) of the conditional statement is executed. In addition, a function may call another function during its execution. The route that the execution of the software program takes is commonly referred to as an execution path.

Execution paths depend on the inputs to the functions because these inputs typically affect the conditional expressions that are tested in the conditional statements. The inputs can vary with each execution of the functions. Therefore, for each execution of the software program, the software program may follow a different execution path or may follow the same execution path depending on how the different inputs affect the conditional statements.

Because some of these execution paths may have an error, testing as many of the execution paths of the software program as possible is advantageous in improving the reliability, safety, security, and robustness of the software program. Therefore, it is desirable to supply different values for the inputs in order to test as many different execution paths as possible. One technique for specifying these different values is by manually specifying the values. However, this technique is labor intensive and can not guarantee that all possible execution paths will be tested.

Techniques that automatically generate values for the inputs typically improve the number of execution paths that are tested. One technique that automatically generates values implements a random generator to randomly choose the values for the inputs. However, randomly choosing the values has a low probability of selecting values that will cause “buggy” behavior (i.e., an error). In addition, randomly choosing the values may test the same execution path a number of times (i.e., redundant executions).

A technique that addresses the problem of redundant executions and increases the number of execution paths that are tested is called symbolic execution. In symbolic execution, the software program is executed using symbolic variables in place of concrete values for the inputs. Each conditional expression (e.g., i>10) for each conditional statement is then represented as a constraint. These constraints are used to determine the concrete values for the input to the software program, and thus, determine which execution path is traversed. The execution paths of the program can be represented as a tree, where each conditional branch in the program represents a node of the tree. The goal of symbolic execution is to generate concrete values for the inputs that will execute different execution paths. Unfortunately, for large or complex programs, it is computationally impractical to precisely maintain and solve the constraints required to generate values for the input. Therefore, symbolic execution does not scale well for large programs.

Another technique combines symbolic execution with concrete execution. In this technique, during concrete execution, symbolic constraints are generated along the path of execution. These constraints are modified and then solved, if feasible, to generate further test inputs which direct the program along an alternate execution path. This is achieved by systematically negating the conjuncts in the path constraint to provide a depth first exploration of the paths in the computation tree. When it is not feasible to solve the modified constraints, a random concrete value is substituted.

One challenge with this technique is extracting and solving the constraints generated by the program. This challenge is particularly difficult for complex programs having dynamic data structures that use pointer operations. Because pointers may have aliases and alias analysis may only be approximate in the presence of pointer arithmetic, using symbolic values to precisely track the pointers may result in constraints that can not be resolved. When this occurs, this technique fails to generate test inputs that will expose “buggy” execution paths. Therefore, this technique does not handle dynamic data structures that use pointer operations.

Thus, there is a continual need to improve the ability of software testing techniques to handle dynamic data structures.

### SUMMARY

The present software testing technique successfully tests software programs that have dynamic data structures and that use pointer operations. The technique iteratively executes the software program using concrete execution and symbolic execution, simultaneously. The concrete execution is driven by inputs generated based on a logical input map, which is updated in conjunction with symbolic execution. The logical input map represents the inputs using finite memory graphs and constants.

### BRIEF DESCRIPTION OF THE DRAWINGS

Non-limiting and non-exhaustive embodiments are described with reference to the following figures, wherein like reference numerals refer to like parts throughout the various views unless otherwise specified. For convenience, the left-most digit of a component reference number identifies the particular Figure in which the component first appears.

FIG. 1 is an illustrative computing device that may be used to implement the software testing technique described herein.

FIG. 2 is a block diagram illustrating exemplary program modules and program data for implementing an instrumentation portion for the present software testing technique within the computing device shown in FIG. 1.

FIG. 3 is a block diagram illustrating exemplary program modules and program data for implementing one embodiment of a runtime portion for the present software testing technique within the computing device shown in FIG. 1.

FIG. 4 illustrates an exemplary syntax for a simple C-like language that is used when performing the instrumentation portion for the present software testing technique.

FIG. 5 illustrates an exemplary procedure written with the C-like language shown in FIG. 4 before and after instrumentation in accordance with one embodiment of the present software testing technique.

FIG. 6 is a flow diagram that illustrates one embodiment of a software testing process that operates within the runtime portion of the present software testing technique.

FIG. 7 is a flow diagram that illustrates one embodiment of a process for providing a test input which is suitable for use within the software testing process of FIG. 6.

FIG. 8 is a flow diagram that illustrates one embodiment of a process for handling a pointer input graph which is suitable for use within the process for providing a test input of FIG. 7.

FIG. 9 is a flow diagram that illustrates one embodiment of a process for symbolically executing an assignment statement which is suitable for use within the software testing process of FIG. 6.

FIG. 10 is a flow diagram that illustrates one embodiment of a process for symbolically evaluating a conditional statement which is suitable for use within the software testing process of FIG. 6.

FIG. 11 is a flow diagram that illustrates one embodiment of a process for checking the predicted path which is suitable for use within the software testing process of FIG. 6.

FIG. 12 is a flow diagram that illustrates one embodiment of a process for solving constraints and determining a new logical input map which is suitable for use within the software testing process of FIG. 6.

FIG. 13 is a flow diagram that illustrates one embodiment of a process for determining a new logical input map when pointers are represented within the logical input map which is suitable for use within the process for solving constraints of FIG. 12.

FIG. 14 is a flow diagram that illustrates one embodiment of a process for updating the symbolic states suitable for use within the process 900 of FIG. 9 when the expression in the assignment statement is a variable.

FIG. 15 is a flow diagram that illustrates one embodiment of a process for updating the symbolic states suitable for use within the process 900 of FIG. 9 when the expression in the assignment statement is an addition or subtraction.

FIG. 16 is a flow diagram that illustrates one embodiment of a process for updating the symbolic states suitable for use within the process 900 of FIG. 9 when the expression in the assignment statement is a multiplication.

FIG. 17 is a flow diagram that illustrates one embodiment of a process for updating the symbolic states suitable for use within the process 900 of FIG. 9 when the expression in the assignment statement is a pointer de-reference.

FIG. 18 is example code and runtime data that is generated during testing of the example code in accordance with the present software testing technique.

### DETAILED DESCRIPTION

The following description is directed at a software testing technique that handles memory graphs. The software testing technique employs a combination of symbolic and concrete execution to generate test inputs that explore feasible execution paths of a software program under test. The behavior of the symbolic execution is captured within a logical input map that drives the iterative concrete execution of the software program under test. The logical input map handles dynamic data structures (e.g., pointers) and primitives. These and other aspects of the present software testing technique are now described in detail.

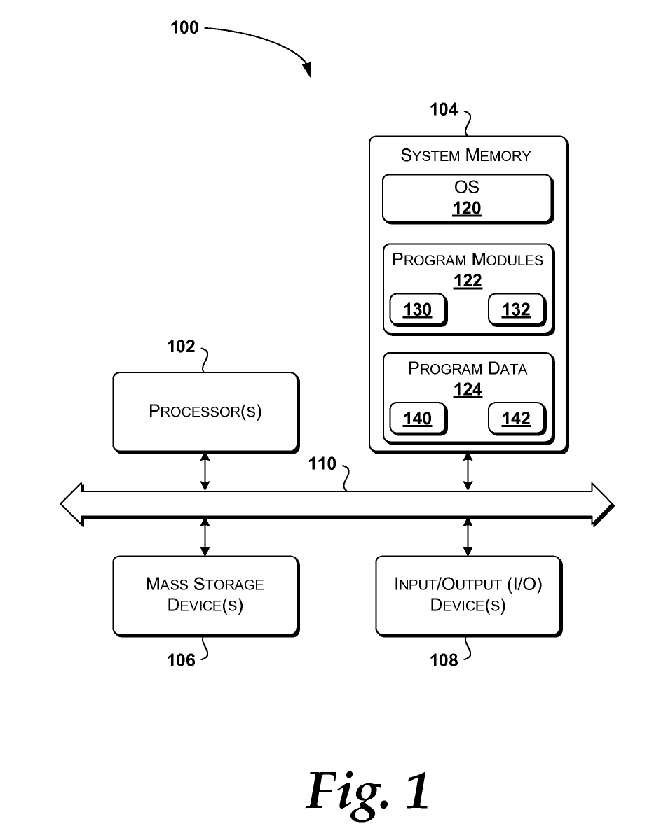

FIG. 1 is an illustrative computing device 100 that may be used to implement an embodiment of the present software testing technique described herein. Computing device 100 represents any type of computing device such as a desktop computer, a server computer, a handheld computer, a notebook computer, and the like.

Computing device 100 includes one or more processor(s) 102, system memory 104, mass storage device(s) 106, input/output (I/O) device(s) 108, and bus 110. Processor(s) 102 include one or more processors or controllers that execute instructions stored in system memory 104 and/or mass storage device(s) 106. Processor(s) 102 may also include computer readable media, such as cache memory.

System memory 104 includes various computer readable media, including volatile memory (such as random access memory (RAM)) and/or nonvolatile memory (such as read only memory (ROM)). System memory 104 may include rewritable ROM, such as Flash memory. System memory 104 typically includes an operating system 120, one or more program modules 122, and program data 124. For the present software testing technique, program modules 122 may include one or more components (e.g., components 130 and 132) for implementing an instrumentation portion and a runtime portion for the software testing technique, respectively. Likewise, program data 124 may include one or more data (e.g., data 140 and 142) for storing instrumented code and runtime data in accordance with the present software testing technique. The program modules 122 and program data 124 for implementing the instrumentation portion and runtime portion are described in detail in conjunction with the remaining figures.

Mass storage device(s) 106 include various computer readable media, such as magnetic disks, optical disks, solid state memory (e.g., flash memory), and so forth. Various drives may also be included in mass storage device(s) 106 to enable reading from and/or writing to the various computer readable media. Mass storage device(s) 106 include removable media and/or non-removable media.

I/O device(s) 108 include various devices that allow data and/or other information to be input to and/or output from computing device 100. Examples of I/O device(s) 108 include cursor control devices, keypads, microphones, monitors or other displays, speakers, printers, network interface cards, modems, lenses, CCDs or other image capture devices, and so forth.

Bus 110 allows processor(s) 102, system memory 104, mass storage device(s) 106, and I/O device(s) 108 to communicate with one another. Bus 110 can be one or more of multiple types of buses, such as a system bus, PCI bus, IEEE 1394 bus, USB bus, and so forth.

Various modules and techniques may be described herein in the general context of computer-executable instructions, such as program modules, executed by one or more computers or other devices. Generally, program modules include routines, programs, objects, components, data structures, etc. for performing particular tasks or implementing particular abstract data types. Typically, the functionality of the program modules may be combined or distributed as desired resulting in various embodiments.

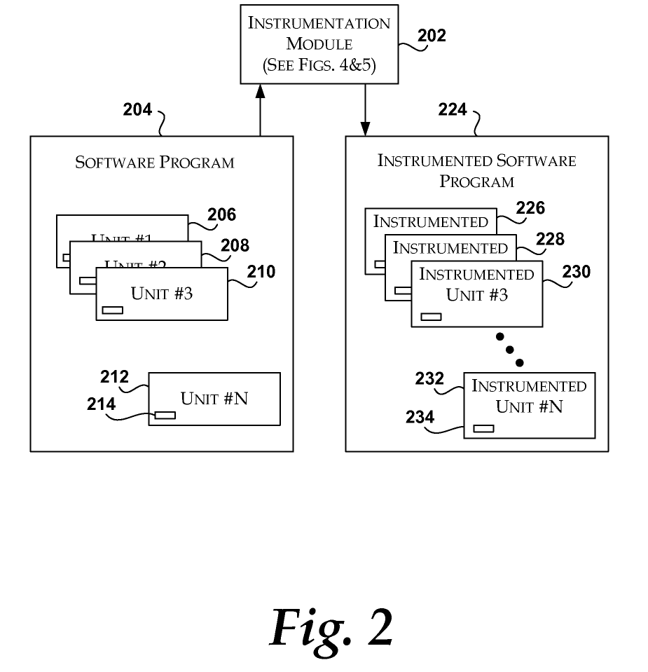

FIG. 2 is a block diagram illustrating an exemplary program module and exemplary program data for implementing an instrumentation portion for the present software testing technique within the computing device shown in FIG. 1. In overview, exemplary instrumentation module 202 adds instructions to a software program 204 which can then be tested in accordance with the runtime portion of present software testing technique. Software program 204 may be written using a programming language, such as C programming language, JAVA programming language, or the like. Software program 204 may be decomposed into several units (i.e., units 206-212). Each of these units may have one or more functions. One of the functions in each unit is designated as an entry function (e.g., entry function 214). As will be described later, inputs are supplied to the entry function 214 in an iterative manner in order to explore the feasible paths of the corresponding unit. The entry function 214 may in turn call other functions within the unit as well as functions that are not in the unit (e.g., library functions). In one embodiment, the unit does not receive input from other sources, such as interactive input from a user, reading a file, a random number generator, or the like. Instead, the present software testing technique generates different inputs for each execution of the unit under test so that different execution paths are tested on each execution.

As mentioned above, each unit may have one or more functions. Each of these functions has statements, some of which are complex statements. Instrumentation module 202 converts the more complex statements into a simplified form by introducing temporary variables. For example, the statement “**v=3” may be converted into “t1=*v” and “*t1=3”; the statement “p[i]=q[j]” may be converted into “t2=q+j”, “t3=p+i”, and “*t3=*t2”. In one embodiment, instrumentation module 202 utilizes a conventional program, such as the CIL framework, to perform this conversion. Additional information about the CIL framework may be obtained from an article entitled “CIL: Intermediate Language and Tools for Analysis and Transformations of C Programs” by G. C. Necula et al. in Proceedings of Conference on Compiler Constructions, pages 213-228, 2002. Instrumentation module 202 may also handle function calls using a symbolic stack.

Instrumentation module 202 then adds instructions to the units 206-212 that are to be tested which results in a corresponding instrumented unit 226-232. While FIG. 2 illustrates each unit 206-212 having a corresponding instrumented unit 226-232, the present software testing technique tests each instrumented unit individually. Therefore, it is not necessary to instrument all the units. Rather, instrumentation module may instrument a portion of the units in software program 204 and then test all or some of these instrumented units.

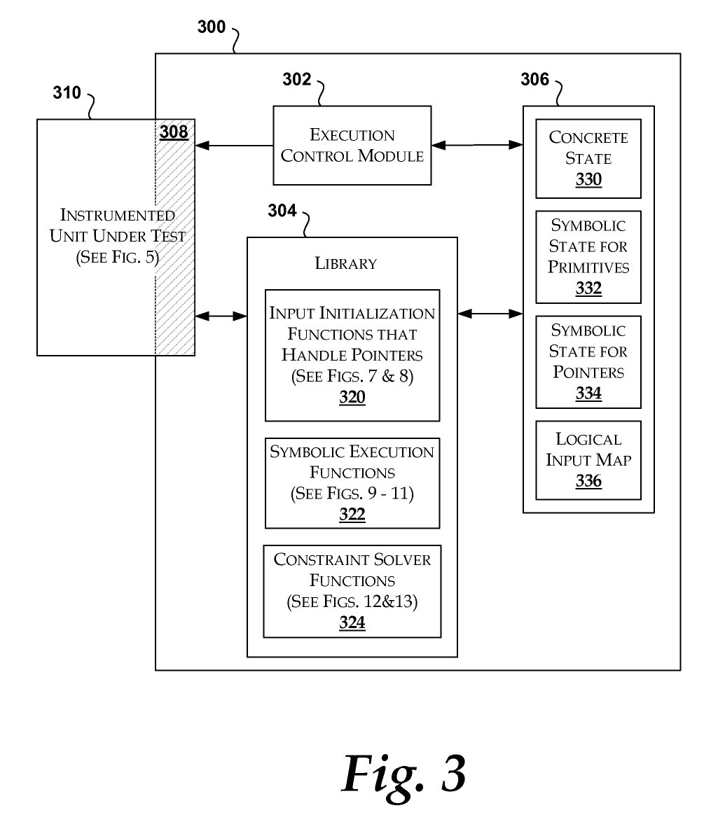

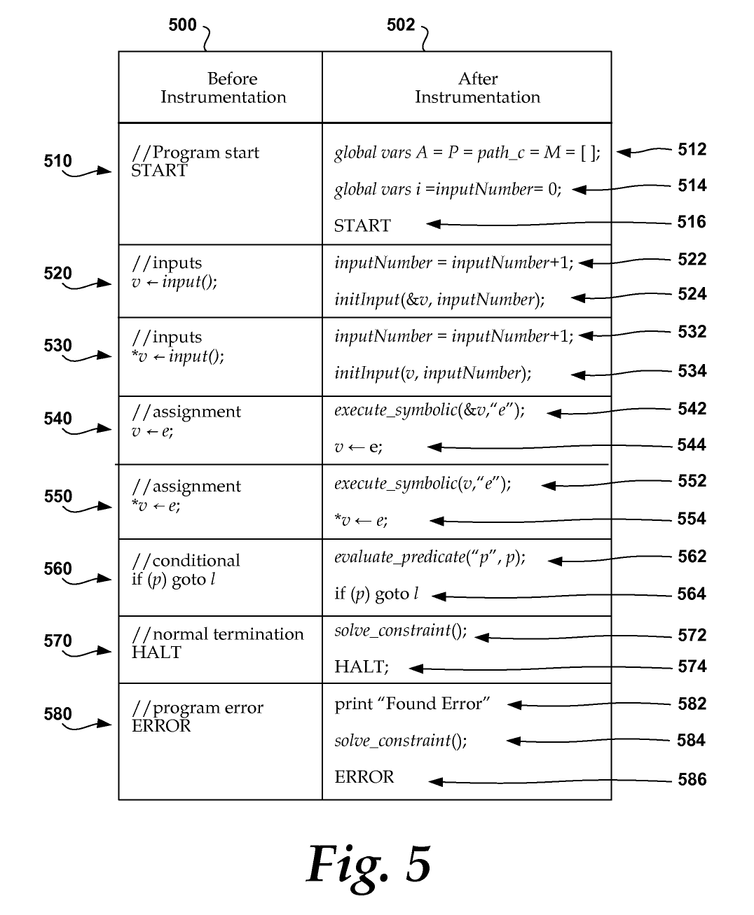

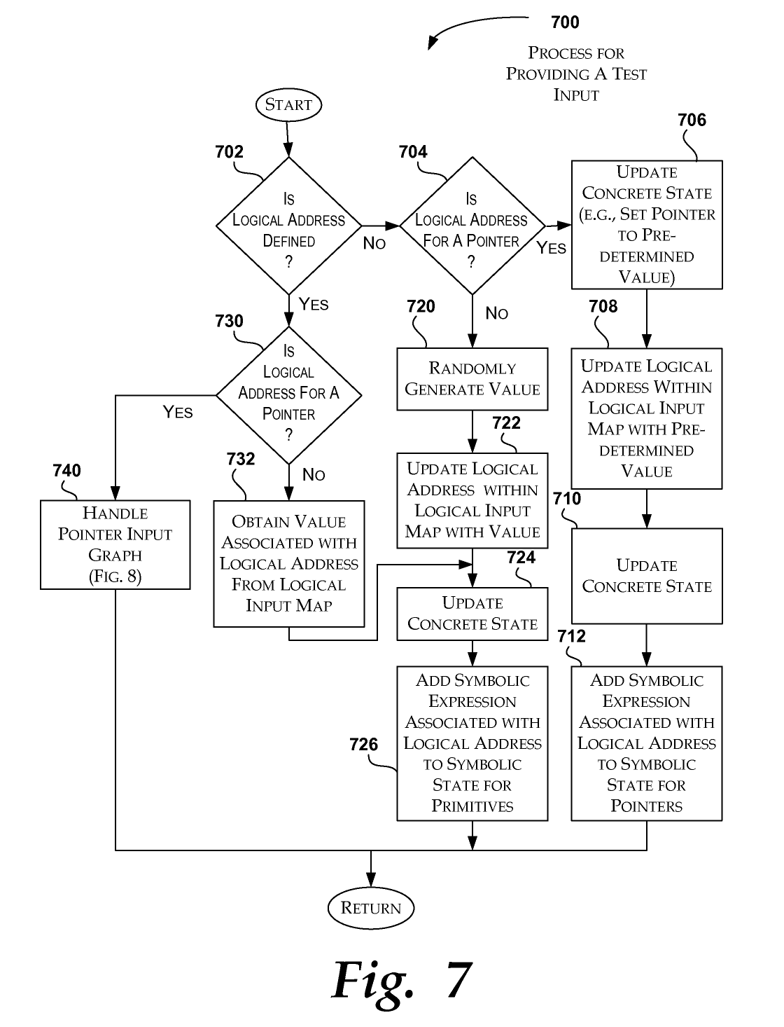

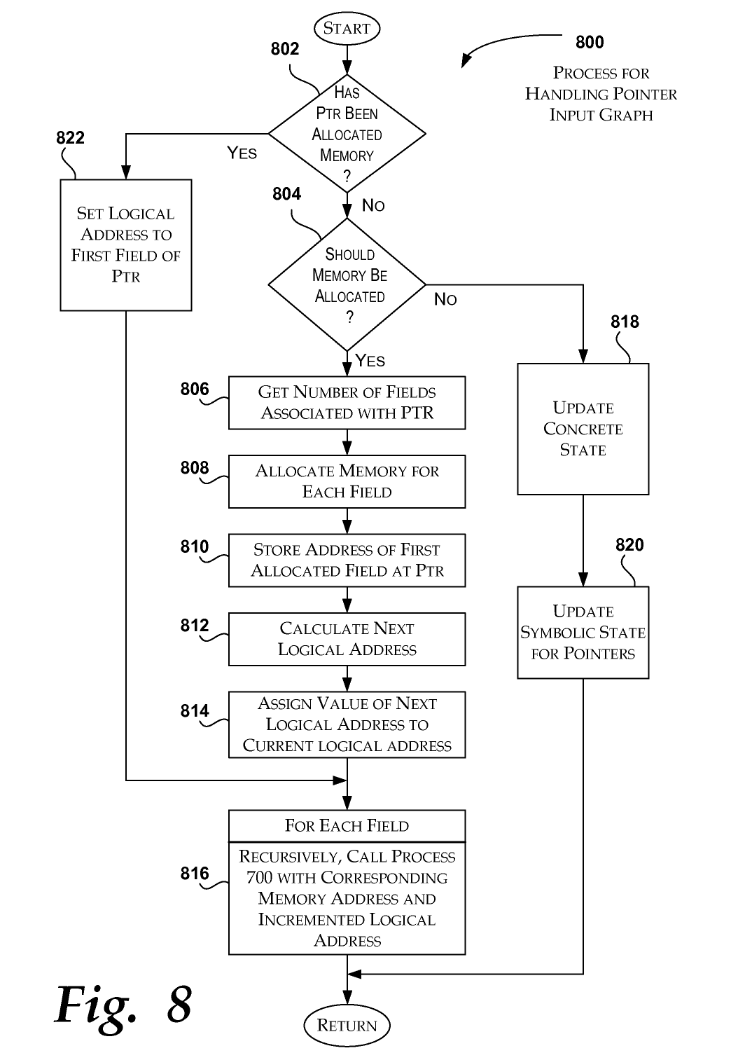

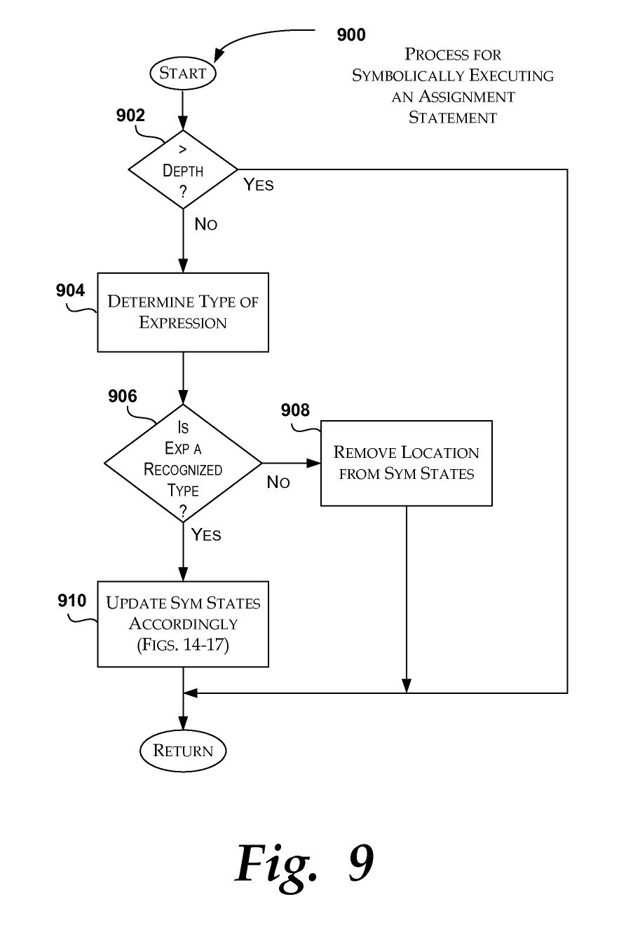

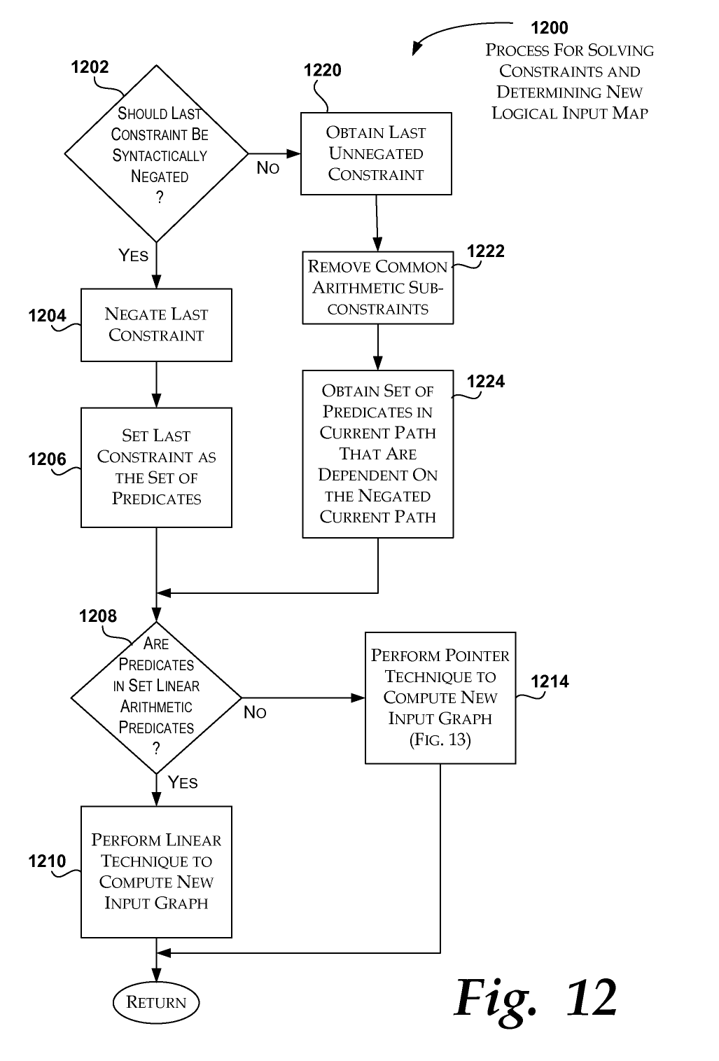

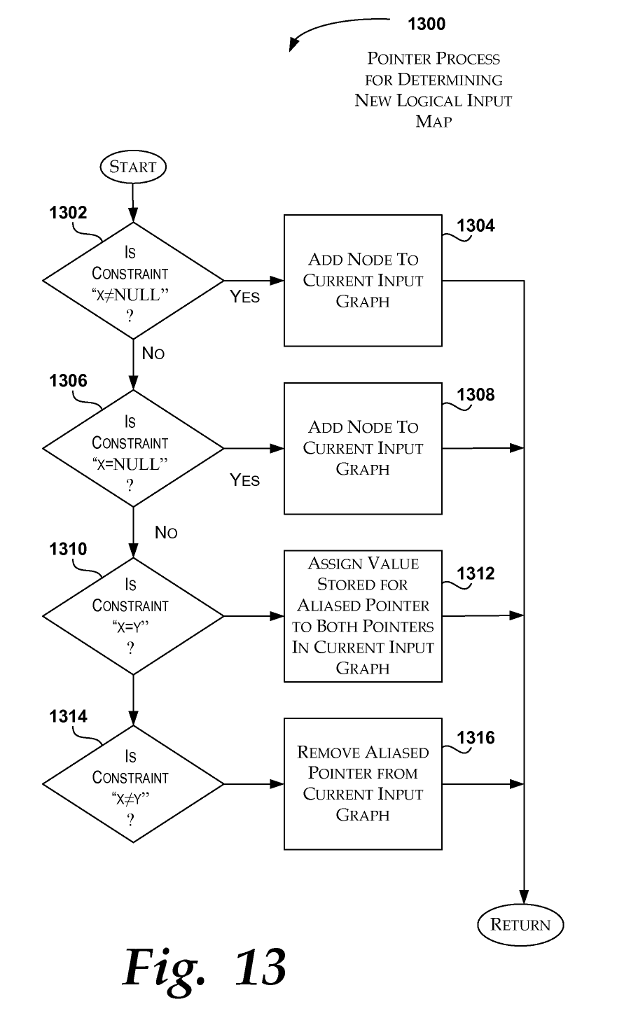

FIG. 3 is a block diagram illustrating exemplary program modules and program data for implementing one embodiment of a runtime portion 300 for the present software testing technique within the computing device shown in FIG. 1. The runtime portion 300 includes an execution control module 302, a library 304, runtime data 306, and instrumented code 308 (shown as a cross-hatched area within a unit under test 310; the area where the unit under test 310 and runtime portion 300 overlap). Briefly, the instrumented code 308, described later in detail in conjunction with FIG. 5, includes calls to functions within library 304. These calls include calls to input initialization functions 320, to symbolic execution functions 322, and to constraint solver functions 324. Input initialization functions 320, described in detail later in conjunction with FIGS. 7 and 8, initializes the memory locations for concrete execution and updates the runtime data 306, accordingly. Symbolic execution functions 322, described in detail later in conjunction with FIGS. 9-11, perform symbolic manipulations on statements and update the runtime data 306, accordingly. The constraint solver functions 324, described in detail later in conjunction with FIGS. 12 and 13, solve path constraints and update the runtime data 306, accordingly. The runtime data 306 includes a concrete state 330, a symbolic state for primitives 332, and a symbolic state for pointers 334, and a logical input map 336. Concrete state 330 maps a physical memory address to a concrete value (e.g., a primitive value or a pointer value). Symbolic states 332, 334 map a physical memory to an expression over symbolic values.

Execution control module 302 controls the execution of the instrumented unit under test 310 in a manner such that the feasible paths of the unit are executed until the testing completes. The testing may complete by traversing each feasible execution path, by obtaining a pre-specified branch or statement coverage, or the like. In overview, on each iteration of executing unit 310, the execution control module supplies inputs to the unit 310 via the instrumented code 308. The inputs that are supplied are based on the concrete execution and the symbolic execution of the previous execution as represented within the logical input map 336. As will be described below, the logical input map represents input for both primitive variables and pointer variables, which allows the present technique the ability to represent and track constraints that capture the behavior of a symbolic execution of an instrumented unit of code having pointers as inputs. The logical input map 336 is maintained between executions. However, the concrete state 330 and the symbolic states 332, 334 are not maintained between executions. As will be described below, the instrumented code 310 is simultaneously run concretely and symbolically, where simultaneous means that during one execution iteration, the instrumented code is executed both concretely and symbolically. In the embodiment described below, the symbolic execution of a statement precedes the concrete execution of the statement. However, the testing technique could be modified to allow the concrete execution of a statement to occur before the symbolic execution of the statement.

In overview, the logical input map 336 represents an input memory graph at the beginning of an execution. The input memory graph maps logical addresses to values that are either logical addresses or primitive values. Logical addresses are used instead of actual concrete addresses of dynamically allocated cells because the actual concrete addresses may change in different executions. It was discovered that the actual concrete addresses of the dynamically allocated cells were not necessary to represent in the memory graphs as long as the manner in which the dynamically allocated cells were connected were maintained. Thus, complex symbolic expressions involving pointers are represented as simple pointer variables within the logical input map. However, the precise pointer relations are maintained within the logical input map. For example, if p is an input pointer to a struct with a field f, then a constraint on p→f will be simplified to a constraint fₒ, where fₒ is the symbolic variable corresponding to the input value p→f. This allows simple pointer constraints of the form x=y or x≠y, where x and y are either symbolic pointer variables or the constant NULL. While this representation introduces some approximations, it was found that the constraints could be efficiently solved and did not appear to hinder the results. In addition, by separating the pointer constraints (i.e., symbolic state for pointers 334) from the arithmetic constraints (i.e., symbolic state for primitives 332), as will be described below, the constraint solving procedure is tractable and more efficient. One will note that constants need not be maintained within either of the symbolic states, but rather their values may be stored in the concrete state 330.

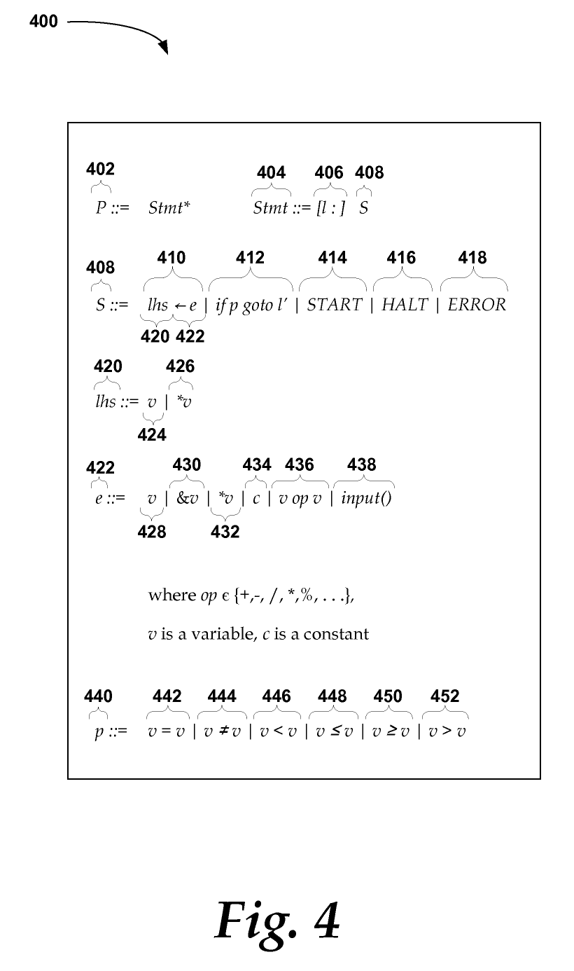

FIG. 4 illustrates an exemplary syntax 400 for a simple C-like language that is used when performing the instrumentation portion for the present software testing technique. While the above syntax for the C-like language is based on well known syntax constructs, it helps explain the processing performed by the instrumentation model 202 when instrumenting the unit under test so that the unit can be tested in accordance with the present software testing technique. In overview, syntax 400 defines a structure for statements within a software program.

In general a program 402 may have several lines of optionally labeled statements (i.e., a sequence of labeled statements). Each labeled statement 404 is in the form of an optional label (e.g., “l:”) 406 followed by a statement 408. Statement 408 may take the form of an assignment 410, a conditional 412, or a keyword (e.g., keywords 414-418). The left hand side 420 of the assignment 410 may be a variable 424 or a dereference 426. The right hand side is an expression 422 that may be a variable 428, an address 440 of a variable, a dereference 432, a constant 434, an operation 436 involving two variables, or input 438. The operation 436 may be any mathematical operation, such as +, −, /, *, and the like. The condition 440 (represented as “p”, which stands for “predicate”) in the conditional 412 may take one of several different forms, such as equal 442, not equal 444, less than 446, equal or less than 448, equal or greater than 450, greater than 452, and the like. The expression &v denotes the address of the variable v and the expression *v denotes the value at the address stored in v. Based on syntax 400, the instrumentation module 202 can instrument the unit under test 310 with instrumented code 308.

FIG. 5 illustrates some exemplary statements written with the C-like language shown in FIG. 4 before and after instrumentation in accordance with one embodiment of the present software testing technique. Code 500 illustrates exemplary statements in a unit under test before instrumentation and Code 502 illustrates the corresponding exemplary statements in an instrumented unit after instrumentation. Code 500 includes a START statement 510 (e.g., keyword 414) at the beginning of the program to designate the start of an entry function. The code also contains two input statements 520 and 530, which assign an input to a primitive variable and a pointer variable, respectively. As shown in FIG. 4, inputs (e.g., 438) are one example of an assignment statement (e.g., assignment 410). However, for the remaining discussion, input statements will be treated separately than other assignment statements so that their effect on the logical input map can be better understood. The code also contains two other assignment statements 540 and 550 that assign an expression to a variable and to memory through a pointer dereference, respectively. The code also contains a conditional statement 560 (e.g., conditional 412 in FIG. 4) and two statements 570 and 580 with keywords (e.g., HALT keyword 416 and EROR keyword 418). HALT keyword 570 denotes normal termination. ERROR keyword 580 denotes a program error in the code of the unit under test.

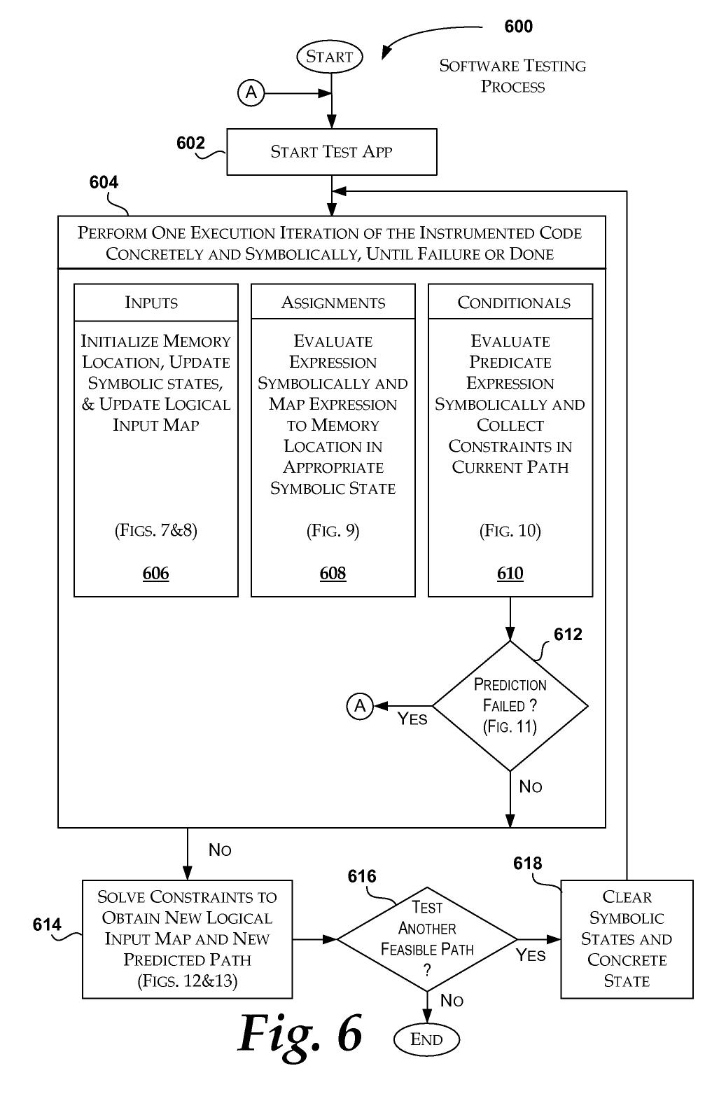

Instrumented code 502 illustrates the exemplary statements of instrumented code 500 after instrumentation is performed in accordance with the present software testing technique. Start statement 510 is instrumented to include two global assignment statements 512 and 514 in addition to a corresponding start statement 516. Global assignment statement 512 assigns an empty set to global variables A, P, and M, which represent the symbolic state for primitives 332, the symbolic state for pointers 334, and the concrete state 330, respectively. Statement 512 assigns an empty array to array path_c. Briefly, these global variables, described later in more detail when describing the software testing process in conjunction with FIG. 6, initialize the symbolic state for primitives, the symbolic state for pointers, the concrete state, and the execution path. Global assignment statement 514 assigns a value of zero to a counter i and an inputNumber variable. The inputNumber maintains a count for the number of inputs needed for executing code 502. As will be described later, the number of inputs needed is based on the number of original arguments to the functions under test, the number of pointers that are maintained in the symbolic state for pointers, and other inputs within the unit under test (if any).

Input statement 520 is instrumented with two statements 522 and 524. Statement 522 increments the inputNumber variable. Statement 524 calls a function (e.g., initInput( )) within library 304 that provides an input value to the variable v. Briefly, function initInput( ), described later in detail in conjunction with FIGS. 7 and 8, translates the logical input map into the concrete state and a corresponding symbolic variable for each input as designated by the corresponding logical address which is associated with the inputNumber. Input statement 530 similarly is instrumented with two statements 532 and 534, which increment the inputNumber variable and provides an input value to a pointer in this case.

Assignment statements 540 and 550 are each instrumented to call a symbolic execution function 542 and 552 (e.g., execute_symbolic( )), respectively, from within library 304 in addition to an assignment statement 544 and 554 that corresponds to the original assignment statements 540 and 550, respectively.

Conditional statement 560 is instrumented to call a symbolic execution function 562 (e.g., evaluate_predicate( ) ), which is within library 304, in addition to the original conditional statement 564.

Keyword statement 570 is instrumented to first call a constraint solver function 572 (e.g., “solve_constraint”), which is within library 304, before the original keyword statement (i.e., statement 574) is executed. Similarly, keyword statement 580 is instrumented to first print a message indicating that an error was found, then call the constraint solver function 584 (e.g., “solve_constraint”), before performing the original keyword statement (i.e., statement 586).

Thus, as will be described, the runtime portion of the present software testing technique executes the instrumented code which simultaneously executes the code concretely using the original statements and symbolically via the instrumented calls to the input functions, the symbolic execution functions, and the constraint solver functions.

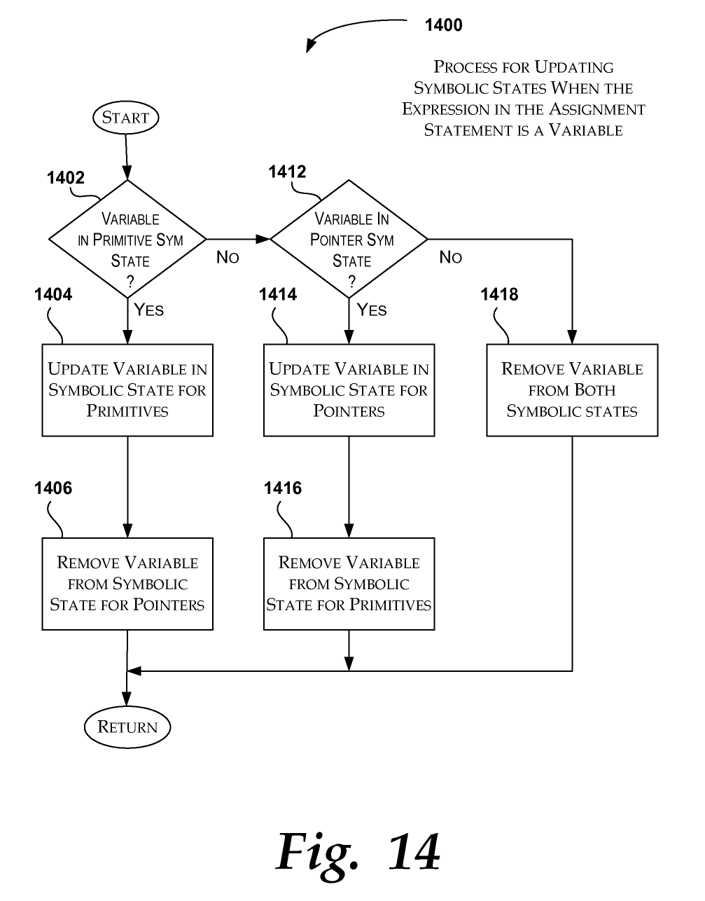

FIG. 6 is a flow diagram that illustrates one embodiment of a software testing process 600 that operates within the runtime portion of the present software testing technique. An example using the processing illustrated in FIGS. 6-13 is described below in conjunction with FIG. 14. Process 600 begins at block 602, where the software testing application is started. In overview, the software testing application is started by specifying the instrumented unit that is to be tested. Given an entry function within the instrumented unit, a main function is generated that will initialize all the arguments of the function by calling an input( ) function. The entry function is then called with these arguments. The instrumented unit, along with the main function, forms a program that can be executed on its own.

In addition, a depth for a bounded depth first search (DFS) may be supplied or may default to a pre-determined value. In overview, the bounded depth first search allows the software testing process to explore paths in an execution tree using a depth first strategy. Each iteration of executing the instrumented code (except the first) executes with the help of a record of the branches that were traversed during prior executions. However, when the length of the execution paths are infinite or long enough to prevent exhaustive search of the whole computation tree, the specified value for the depth stops the present software testing technique from executing the instrumented code at a further depth, thus, preventing inefficient testing. The Table 1 contains pseudo-code that illustrates one embodiment for starting the test application with a bounded depth first search implemented.

TABLE 1

run_test(P, depth)

I = [ ]; h = (number of arguments in P) +1;
completed = false; branch_hist = [ ];
while not completed

execute P

P represents the instrumented program to test, depth is the depth of the bounded DFS, I represents the logical input map, and branch_hist stores the branches that were traversed during the execution path of each iteration (e.g., path constraint). Thus, the branch_hist represents the execution paths that have already been tested. The logical input map I is initialized as an empty array at the beginning of the test and is, thereafter, updated and maintained after each execution iteration. As will be described below, during each execution iteration, the branch_hist array is updated to reflect the current path constraint. The instrumented unit of code (e.g., P) is then executed until the test is completed, which may occur upon an error, upon testing each of the execution paths, upon reaching the depth specified for the DFS, or the like. Processing continues at block 604.

At block 604, one execution iteration is performed on the instrumented code. As described above in conjunction with FIG. 5, the instrumented code executes input statements (block 606), assignment statements (block 608), and conditionals (block 610). Each of the statements within the instrumented code is executed symbolically and concretely as they are encountered. The concrete execution of the instrumented code uses conventional techniques and is not further described. The following describes the symbolic execution of the instrumented code.

At block 606, a test input is determined for each input statement that is encountered. The input statement may be encountered anywhere from the beginning to the end of the code. The logical input map is translated to obtain the concrete state and to update the symbolic state for the associated input. Briefly, determining the value for the test input, described in detail later in conjunction with FIGS. 7 and 8, initializes the memory location associated with the input and updates the symbolic states in accordance with the input. The goal is to have the values for the inputs cause a different execution path to be traversed during this execution iteration than prior execution paths.

At block 608, each assignment statement that is encountered is executed symbolically and concretely. As mentioned above, the instrumented code includes the original statements from the original software program along with the added instrumented calls to the symbolic execution functions. Briefly, the symbolic execution function for handling assignments (e.g., “execute_symbolic( )”), described in detail later in conjunction with FIG. 9, evaluates an expression symbolically and maps the expression to a memory location in the appropriate symbolic state.

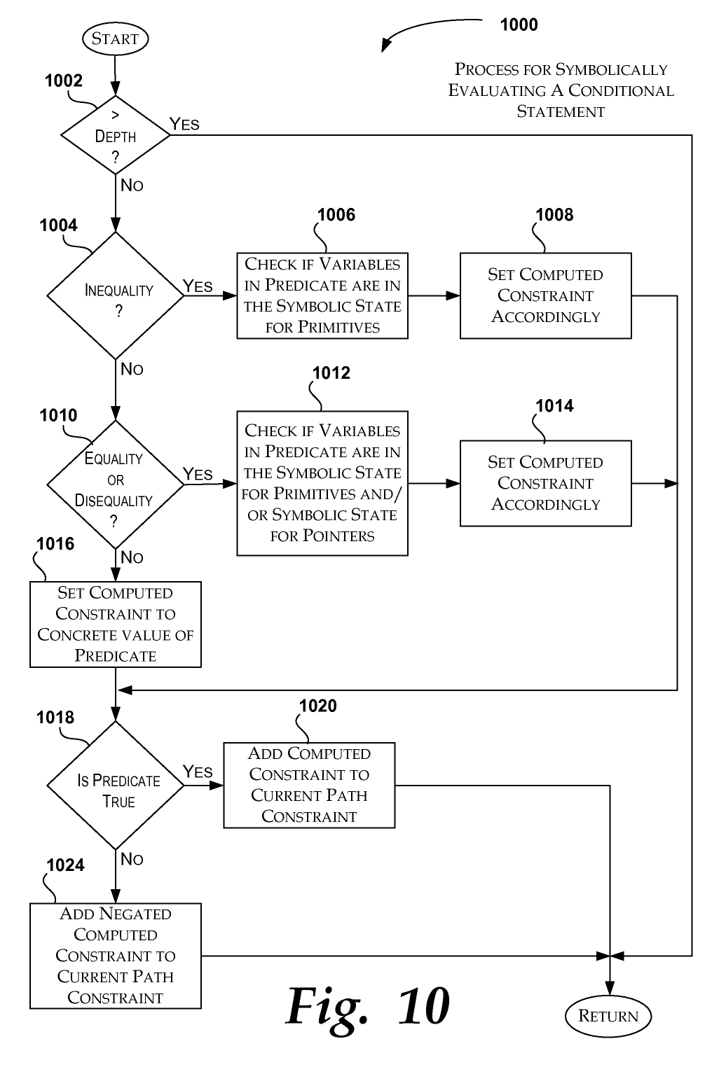

At block 610, each conditional statement that is encountered is executed symbolically and concretely. Briefly, the symbolic execution function for handling conditionals (e.g., “evaluate_predicate( )”), described in detail later in conjunction with FIG. 10, symbolically evaluates the predicate expression of the conditional statement, collects the constraint associated with the conditional statement, and represents the constraint in the current path constraint. The current path constraint is saved in the branch_hist array (described above).

After a conditional statement is processed, processing continues at decision block 612. At block 612, the current path is compared with the predicted path to determine whether testing is proceeding as expected. Upon noticing that the paths differ, processing may terminate and process 600 may be restarted. By restarting process 600, new inputs will be generated that will explore new paths. One will note that once testing is restarted, there is no predicted path for the first iteration. If the prediction is successful, another statement is processed by block 606, 608, or 610. Similarly, when blocks 606 and 608 complete processing of the current statement, the next statement is processed according to one of the blocks 606-610 until there is a failure or until all the statements have been processed.

At block 614, the constraints involving the symbolic variables are solved in order to obtain a new logical input map and a new predicted path, which are then saved. Briefly, solving the constraints, described in detail in conjunction with FIGS. 12-13, negates one of the constraints within the current path constraint, determines values which would satisfy the new path constraint, and saves the values in a new logical input map. The new logical input map is then used in initializing the concrete state and the symbolic states on the next iteration. Processing continues at decision block 616.

At decision block 616, a determination is made whether to test another feasible path. If each feasible path has been tested, processing is complete. An indication that no errors were found in the instrumented code may be provided or a report of all the errors discovered during testing may be reported. If another feasible path is to be tested, processing continues at block 618.

At block 618, the symbolic states and the concrete state are cleared. Thus, the subsequent iterations utilize the logical input map to initialize the contents of the concrete state and the symbolic states. Processing then loops back to block 604 where the new logical input map is used to initialize the concrete state and the symbolic states. The input, assignment, and conditional statements are executed as described above.

FIG. 7 is a flow diagram that illustrates one embodiment of a process for providing a test input which is suitable for use within the software testing process of FIG. 6. In overview, process 700 uses the logical input map to translate values into the concrete state and to create symbolic variables. Process 700 begins at decision block 702 where a determination is made whether the logical address is defined within the logical input map. In one embodiment, a counter, such as inputNumber, is used to identify logical addresses for the inputs. If the logical address has not been previously defined, such as for the first execution iteration for the arguments to the functions within the unit under test and subsequent execution iterations involving memory graphs of pointers, processing continues at block 704. Otherwise, processing continues at block 730.

At decision block 704, a determination is made whether the logical address is associated with a pointer. If the logical address is associated with a pointer, processing continues at block 706. Otherwise, processing continues at block 720.

At block 706, the concrete state is updated, accordingly. Thus, the physical address associated with the logical address is set to a pre-determined values, such as NULL (e.g., 0). Thus, the concrete state of the program will have a value of NULL for the pointer. Processing continues at block 708.

At block 708, the logical input map is updated with the pre-determined value for the associated logical address. In one embodiment, a representation of the logical input map may take the form of (l₁, l₂, l₃, . . . ) where lₓ represents the value for logical address x. For example, if the pointer was the first and only input, the logical input map would appear as <0>. This representation of the logical input map provides a simple way to serialize a memory graph. The representation v=I(l) then refers to the value within the logical input map for logical address l. Processing continues at block 710.

At block 710, the pre-determined value is assigned to the physical address associated with the logical address. Thereby, updating the concrete state. Thus, the concrete execution will utilize this value during this execution. Processing continues at block 712.

At block 712, a symbolic variable associated with the logical address is added to the symbolic state for pointers. The symbolic variable at this time is equal to itself. As will be described, the symbolic variable may be modified later by an assignment statement. Adding the symbolic variable may utilize any conventional technique. However, for the present software testing technique, primitives and pointers are separated into their own symbolic states. Processing for this input is then complete. Process 700 is repeated each time an input statement is encountered within the instrumented code. After an input value has been provided for this input, processing returns to FIG. 6.

At decision block 704, if it is determined that the logical address is not a pointer, processing continues at block 720. In other words, the logical address is for a primitive variable. At block 720, a random value is generated. Any conventional technique for generating a random value may be utilized. Processing continues at block 722.

At block 722, the randomly generated value is stored in the logical input map associated with the current logical address. Processing continues at block 724.

At block 724, the randomly generated value is assigned to the physical address associated with the logical address. Thereby, updating the concrete state. Thus, the concrete execution will utilize this value during this execution. Processing continues at block 726.

At block 726, a symbolic variable associated with the logical address is added to the symbolic state for primitives. Again, the symbolic variable at this time is equal to itself. Processing for this logical address is then complete and returns to FIG. 6.

Referring back to decision block 702, the manner in which the decision whether the logical address has already been defined is now described in further detail. The determination is based on the logical input map. For example, on each execution iteration of the instrumented code, the inputNumber variable is reset to 0. Therefore, each argument to the entry function (see FIG. 5) utilizes the same inputNumber for each execution iteration. The inputNumber corresponds to the logical address within the logical input map. Therefore, after the first execution iteration, the logical input map will have values assigned for these logical addresses, which result in processing continuing at decision block 730.

At decision block 730, a determination is made whether the logical address is for a pointer. If the logical address is for a pointer, processing continues at block 740, otherwise, processing continues at block 732.

At block 732, a value associated with the logical address is obtained from the logical input map. Processing then proceeds to blocks 724 and 726, described above, where the concrete state and the symbolic state for primitives are updated accordingly. Processing for this logical address is then complete and returns to FIG. 6.

At decision block 730, if it is determined that the logical address is for a pointer, processing continues at block 740. Briefly, block 740, described in detail later in conjunction with FIG. 8, handles an input graph for the pointer. In other words, primitive variables and pointer variables referenced by the pointer are added to the appropriate symbolic state and to the concrete state, as needed. In addition, additional memory may be allocated to accommodate having the pointer fulfill a non-NULL constraint. Once the pointer input graph of block 740 is complete, processing returns to FIG. 6.

FIG. 8 is a flow diagram that illustrates one embodiment of a process for handling a pointer input graph which is suitable for use within the process for providing a test input illustrated in FIG. 7. In overview, process 800 attempts to provide “valid” input values for pointers so that the concrete execution can successfully execute when the constraint associated with the pointer specifies a non-NULL value. Processing begins at decision block 802.

At decision block 802, a determination is made whether the pointer has already been allocated memory. This determination is based on the value stored within the logical input map associated with the pointer. For example, in one embodiment, three values may be used in this determination: 1) a value of “0” represents that the pointer is NULL and there is no constraint forcing it to be non-NULL; 2) a value of “−1” represents that the pointer has not been allocated memory, but there is a constraint forcing it to be non-NULL; and 3) a positive integer represents that the pointer has been allocated memory and the value of the positive integer represents the logical address within the logical input map associated with the pointer's first field. Because pointers are initialized to NULL, the first time that a pointer proceeds through process 800, the process continues at decision block 804.

At block 804, a determination is made whether memory should be allocated. As outlined above, this occurs when the constraint solver has set a constraint such that the pointer should not be NULL. Processing then continues at block 806. However, if there is no constraint forcing the pointer to be non-NULL, processing continues at block 818.

At block 818, the concrete state associated with the current logical address (i.e., the pointer) is set to NULL using conventional techniques. Processing continues at block 820.

At block 820, the symbolic state for pointers is updated. The symbolic state for pointers is updated by adding a symbolic variable for the pointer into the symbolic state. As mentioned above in conjunction with FIG. 6, because the concrete state and the symbolic states are cleared before each iteration. Blocks 818 and 820 re-populate the data according to the new logical input map.

If memory needs to be allocated for the pointer at decision block 804, processing continues at block 806. At block 806, the number of fields associated with the pointer is obtained so that sufficient memory is allocated based on the type of pointer in block 808. At block 810, the concrete state for the pointer is updated by storing the address of the first allocated field in the pointer. At block 812, the next available logical address within the logical input map is calculated. Because the logical input map needs to expand in order to accommodate the fields for this pointer, the last logical address is incremented by one to obtain the next logical address. At block 814, the value of the next logical address is stored as the current logical address so that process 700 can be called recursively for each field at block 816. The logical address is incremented for each new field. Then, before returning to FIG. 6, the logical address is set to the next logical address after the pointer. Thereby, keeping the logical address associated with specific input consistent between iterations.

If memory has already been allocated, blocks 806-814 may be skipped and instead at block 822 the logical address is set to the logical address that corresponds to the first field of the pointer. This logical address is stored in the logical input map at the logical address associated with the pointer. By linking the pointer and its field in this manner within the logical input map, the logical input map provides a simple way to serialize a memory graph that includes pointer variables. Process 800 is then complete and returns to FIG. 6.

Table 2 illustrates exemplary code that provides input for primitive variables and pointer variables in accordance with the present software testing technique.

TABLE 2
// input: m is the physical address to initialize

| | |
|---|---|
| // | l is the corresponding logical address |

// modifies h, I, A, P, M
initInput(m, l)

if 1 ∉ domain(I)

if (typeOf (*m) == pointer to T) *m = NULL;
else *m = random( );
I = I[l [symbol] *m];

else

v = I(l);
if (typeOf (v) == pointer to T)

if (v ε domain(M))

*m = M(v);

else

n = sizeOf (T);
{m₁, . . . ,mₙ} = malloc(n);
if (v == non-NULL)

v′ = h; h = h + n; // h is the next logical address

else

v′ = I(l)

*m = m₁; I = I[l [symbol] v′]; M = M[v [symbol] m₁];
for j = 1 to n

input(mⱼ , h + j − l);

else

*m = v; I = I[l [symbol] v];

// x₁ is a symbolic variable for logical address l
if (typeOf (m) == pointer to T) P = P[m [symbol] x₁];
else A = A[m [symbol] xₗ];

FIG. 9 is a flow diagram that illustrates one embodiment of a process 900 for symbolically executing an assignment statement which is suitable for use within the software testing process of FIG. 6. Process 900 begins at an optional decision block 902. Optional decision block 902 is implemented if a depth has been set for a bounded depth first search. At decision block 902, a determination is made whether the set depth has been reached. Having a bounded depth-first search allows the present software testing technique the ability to generate a variety of finite sized data structures when using preconditions such as data structure invariants. For example, if an invariant is used to generate sorted binary trees, a non-bounded depth-first search would result in an infinite number of trees whose every node has at most one left children and no right children. Thus, in one embodiment, the depth is assigned a default value which may be overridden with a user supplied value. If the depth has been reached, symbolic processing is not performed and processing proceeds to the return. Otherwise, processing continues at block 904.

At block 904, the type of expression in the assignment statement is determined. As discussed in conjunction with FIG. 4, an expression may be a variable 428, an address 440 of a variable, a dereference 432, a constant 434, an operation 436 involving two variables, or input 438. Processing continues at decision block 906.

At decision block 906, a determination is made whether the type of expression is a recognized type. If the type of expression is not a recognized type of expression, processing continues at block 908 where the location(s) are removed from the symbolic states. However, if the type of expression is a recognized type of expression, processing continues at block 910.

At block 910, the symbolic states are updated according to the type of expression. FIGS. 14-17 illustrate how the symbolic states are updated for different types of expression. Processing 900 is then complete.

FIG. 14 is a flow diagram that illustrates one embodiment of a process for updating the symbolic states suitable for use within the process 900 of FIG. 9 when the expression in the assignment statement is a variable assignment, such as y=x, where the assignment may be for pointers or for primitives. At decision block 1402, a determination is made whether x is in the symbolic state for primitives. If it is, processing continues at block 1404 and block 1406. At block 1404, the symbolic state for primitives is updated to reflect that the symbolic state of y is now equal to the symbolic state of x. At block 1406, x is removed from the symbolic state for pointers, if it exists in the symbolic state for pointers. Processing then returns.

If x is not in the symbolic state for primitives, processing continues at decision block 1412, where a determination is made whether x is in the symbolic state for pointers. If it is, processing continues at block 1414 and block 1416. At block 1414, the symbolic state for pointers is updated to reflect that the symbolic state of y is now equal to the symbolic state of x. At block 1416, x is removed from the symbolic state for primitives if it exists there. Processing then returns.

If x is not in either the symbolic state for primitives or the symbolic state for pointers, processing continues at block 1516 where x is removed from both symbolic states. Processing then returns.

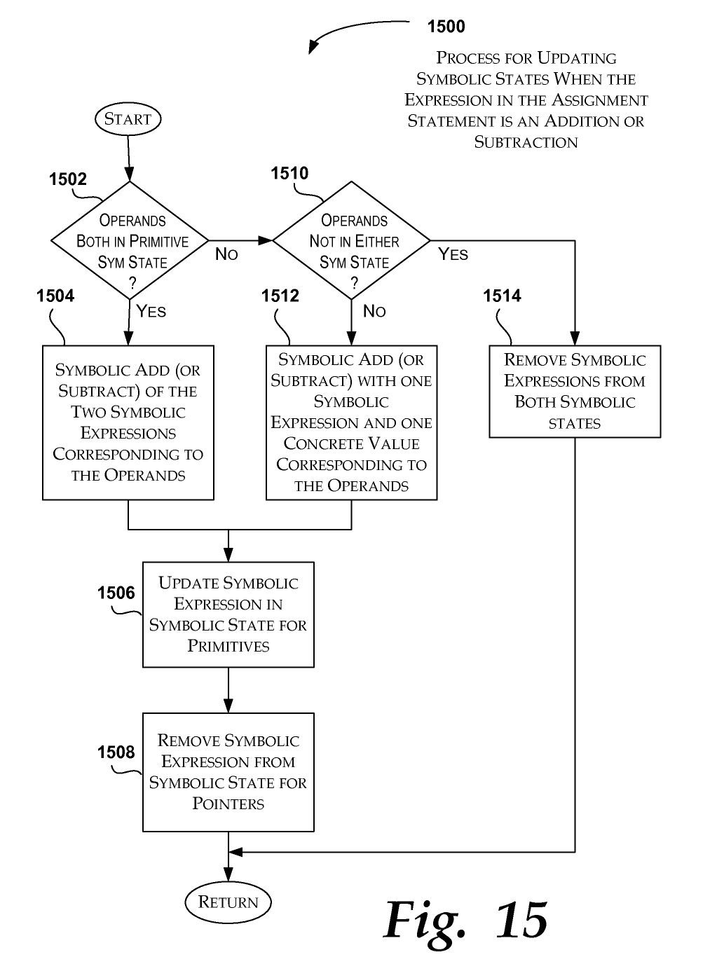

FIG. 15 is a flow diagram that illustrates one embodiment of a process for updating the symbolic states suitable for use within the process 900 of FIG. 9 when the expression in the assignment statement is an addition or subtraction. At decision block 1502, a determination is made whether both operands are in the symbolic state for primitives. Because the present testing technique has pointer constraints that are either “equal to NULL”, “not equal to NULL”, “equal to”, or “not equal to”, process 1500 does not need to check the symbolic state for pointers. Even though this is not precise, the technique scales better, runs faster, and achieves successful results. If both operands are in the symbolic state for primitives, processing continues at block 1604 where a symbolic add (or subtract) with two symbolic expressions is performed. Processing continues at where the left hand operand is updated in the symbolic state for primitives (block 1506) and is removed from the symbolic state for pointers (block 1508). Processing then returns.

If both operands are not in the symbolic state for primitives, processing continues at decision block 1510. At decision block 1510, a determination is made whether one of the operands is in the symbolic state for primitives. If this is true, a symbolic add (or subtract) is performed the one operand in the symbolic state for primitives and a concrete value corresponding to the other operands (block 1512). Processing then continues to block 1506 and 1508 before returning.

If there is not an operand within the symbolic state for primitives, the symbolic expression is removed from both symbolic states. Processing is then complete.

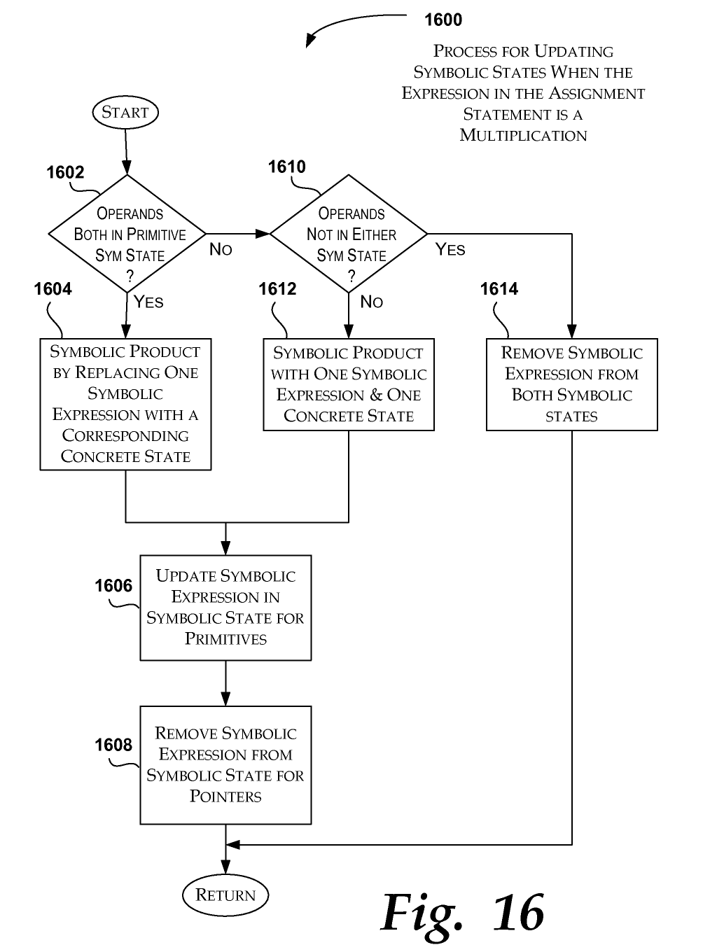

FIG. 16 is a flow diagram that illustrates one embodiment of a process for updating the symbolic states suitable for use within the process 900 of FIG. 9 when the expression in the assignment statement is a multiplication. At decision block 1702, a check is performed to determine whether the operands are both in the primitive symbolic state. If both operands are in the symbolic state for primitives, processing continues to block 1604, block 1606, and block 1608 before returning. At block 1604, a symbolic product is performed by replacing one symbolic expression with a corresponding concrete state. At block 1606, the symbolic state for primitives is updated. At block 1608, the symbolic expression is removed from the symbolic state for pointers.

If the operands are not in the primitive symbolic state, processing continues at decision block 1610. At decision block 1610, a determination is made whether at least one operand is the symbolic state for primitives. If this is true, a symbolic product is performed with one symbolic expression and one concrete state (block 1612) before proceeding to blocks 1606-1608. One will note that the symbolic state for pointers need not be evaluated if multiplication of pointers is not supported. If none of the operands are in the primitive symbolic state, both locations are removed from the symbolic state (block 1614). Processing is then complete.

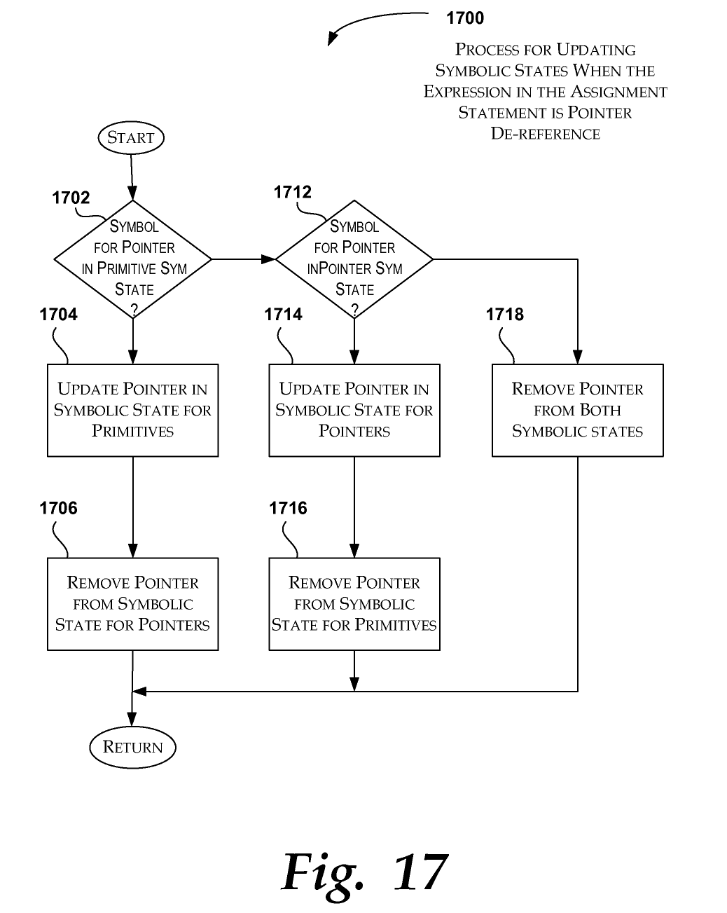

FIG. 17 is a flow diagram that illustrates one embodiment of a process for updating the symbolic states suitable for use within the process 900 of FIG. 9 when the expression in the assignment statement is a pointer de-reference. At decision block 1702, a check is performed to determine whether the symbol for the pointer is in the symbolic state for primitives. If so, processing continues to block 1704 and block 1706, before returning. At block 1704, the pointer symbol in the symbolic state for primitives is updated. At block 1806, the pointer is removed from the symbolic state for pointers.

If the symbol for the pointer was not in the symbolic state for primitives, processing continues at decision block 1712. At decision block 1712, a check is made to determine whether the symbol for the pointer is within the symbolic state for pointers. If the symbol for the pointer is in the symbolic state for pointers, processing continues to block 1714 and block 1716, before returning. At block 1714, the pointer symbol in the symbolic state for pointers is updated. At block 1806, the pointer is removed from the symbolic state for primitives. If the symbol for the pointer is not within either symbolic state, the pointer is removed from both symbolic states. Processing is then complete.

Table 3 illustrates exemplary code that symbolically executes an assignment statement.

TABLE 3
// inputs: m is a memory location

| | |
|---|---|
| // | e is an expression to evaluate |

// modifies A and P by symbolically executing *m [symbol] e
execute symbolic(m, e)

if (i ≦ depth)
match e:

case “v₁”:

m₁ = &v₁;
if (m₁ ε domain(P)) A = A − m; P = P [m [symbol] P (m₁)];
//remove if A contains m
else if (m₁ ε domain (A)) A = A [m [symbol] A (m₁)]; P = P − m;
else P = P − m; A = A − m;

case “v₁ ± v₂”: // where ± ε {+, −}

m₁ = &v₁; m₂ = &v₂;
if (m₁ ε domain (A) and m₂ ε domain (A)) v = “A (m₁) ±
A (m₂)”; //symbolic add or subtract
else if (m₁ ε domain (A)) v = “A (m₁) ± v₂”; //symbolic
add or subtract
else if (m₂ ε domain (A)) v = “v₁ ± A (m₂)”; //symbolic
add or subtract
else A = A − m; P = P − m; return;
A = A [m [symbol] v]; P = P − m;

case “v₁ * v₂”:

m₁ = &v₁; m₂ = & v₂;
if (m₁ ε domain (A) and m₂ ε domain (A)) v = “v₁ * A
(m₂)”;//replace one with concrete val
else if (m₁ ε domain (A)) v = “A (m₁) * v₂”; //symbolic
multiply
else if (m₂ ε domain (A)) v = “v₁ * A (m₂)”; //symbolic
multiply
else A = A − m; P = P − m; return;
A= A [m [symbol] v]; P = P − m;

case “*v₁”:

m₂ = v₁;
if (m₂ ε domain (P)) A = A − m; P = P [m → P (m₂)];
else if (m₂ ε domain (A)) A = A [m [symbol] A (m₂)]; P = P − m;
else A = A − m; P = P − m;

default:

A = A − m; P = P − m;

A represents the symbolic state for primitives, P represents the symbolic state for pointers, m is a memory location, and e is an expression to evaluate. Given any map M (e.g., A or P), M′=M [m [symbol] v] denotes the map that is the same as M except that M′(m)=v. Also, M′=M−m denotes the map that is the same as M except that M′(m) is undefined. The notation mεdomain(M) represents a check whether M (m) is defined.

FIG. 10 is a flow diagram that illustrates one embodiment of a process 1000 for symbolically evaluating a conditional statement which is suitable for use within the software testing process of FIG. 6. Process 1000 begins at optional decision block 1002. Optional decision block 1002 is implemented if a depth has been set for a bounded depth first search. At decision block 1002, a determination is made whether the set depth has been reached. If the depth has been reached, symbolic processing is not performed and processing proceeds to the return. Otherwise, processing continues at decision block 1004.

At decision block 1004, the predicate is checked to determine whether it is an inequality, such as <, >, or the like. If the predicate is not an inequality, processing continues at decision block 1010. Otherwise, processing continues at block 1006.

At block 1006, the primitive variables are checked to determine whether they are within the symbolic state for primitives. Because the present software testing technique uses pointer constraints that conform to x=y, x≠y, x=NULL, and x≠NULL, the symbolic state for pointers need not be checked at block 1006. After this determination, processing continues at block 1008 where a computed constraint is set. If both variables are in the symbolic state for primitives, both their symbolic expressions are used to set the computed constraint in block 1008. For example, if x₁ and x₂ are in the symbolic state, then the computed constraint may be x₁>x₂. However, if one of the variables does not have a corresponding symbolic expression, the variable itself may be used to set the computed constraint. For example, for x>1, the number one does not have a corresponding symbolic expression, therefore, the computed constraint is x>1. Processing continues at decision block 1018.

At decision block 1018, the concrete value of the predicate is evaluated. In essence, the concrete value represents the outcome (e.g., true/false may correspond to if/then outcome, respectively) of the branch that was traversed. If the concrete value is true, processing continues at block 1020 where the current path constraint is extended with the computed constraint. Otherwise, processing continues at block 1024, where the current path constraint is extended with the negated computed constraint. The current path constraint represents the execution path for the current iteration. Processing then returns to FIG. 6.

At decision block 1010, the predicate is evaluated to determine whether it is an equality or a disequality, such as = or ≠. If the predicate is an equality or a disequality, processing continues at block 1012. At block 1012, both of the symbolic states are checked for the variables. Processing then continues at block 1014 where the computed constraint is set. The computed constraint is computed as described above except that the constraint is an equality or a disequality. It is important to note that even though simple pointer constraints are used, a precise relationship between pointers is maintained in the logical input map. The logical input map (through types) maintains a relationship between pointers to structs and their fields and between pointers to arrays and their elements. Thus, the logical input map allows the use of simple scalar symbolic variables to represent the memory and still obtains fairly precise constraints. Processing continues to decision block 1018 and proceeds as described above.

If the predicate is not an inequality or equality/disequality, then processing continues at block 1016, where the computed constraint is set to the concrete value of the predicate. This represents a case in which the symbolic predicate expression is constant. Therefore, a constraint can not be changed to test the other path. Processing continues to decision block 1018 and proceeds as described above.

In one embodiment, the symbolic expressions from the branching points due to the conditional statements in the software program are collected in an array that represents the current path constraint. At the end of the execution, the current path constraint, path_c[0 . . . i−1], where i is the number of conditional statements in the instrumented code, contains the predicates whose conjunction holds for the current execution path. By saving the execution path for each execution iteration of the instrumented code, process 600 can determine when the feasible paths of the instrumented code have each been tested. Table 4 illustrates exemplary pseudo-code that symbolically evaluates a predicate.

TABLE 4

| // inputs: p is a predicate to evaluate | |
|---|---|
| // | b is a memory location |

// modifies path_c by symbolically evaluating p
evaluate_predicate(p, b)
if (i ≦ depth)

match p:

case “v₁ ∞ v₂”: // where ∞ ε {<,≦,≧,>}

m₁ = & v₁; m₂ = & v₂;
if (m₁ ε domain(A) and m₂ ε domain(A))

c = “A(m₁) − A(m₂) ∞ 0”;

else if (m₁ ε domain(A))

c = “A(m₁) − v₂ ∞ 0”;

else if (m₂ ε domain(A))

c = “v₁ − A(m2) ∞ 0”;

else c = b;

case “v₁ ≈ v2”: // where ≈ ε {=, ≠}

m₁ = & v₁; m₂ = & v₂;
if (m₁ ε domain(P) and m₂ ε domain(P))

c = “P(m₁) ≈ P(m₂)”;

else if (m₁ ε domain(P) and v₂ == NULL)

c = “P(m₁) ≈ NULL”;

else if (m₂ ε domain(P) and v₁ == NULL)

c = “P(m₂) ≈ NULL”;

else if (m₁ ε domain(A) and m₂ ε domain(A))

c = “A(m₁) − A(m₂) ≈ 0”;

else if (m₁ ε domain(A)) c = “A(m₁) − v₂ ≈ 0”;
else if (m₂ ε domain(A)) c = “v₁ − A(m₁) ≈ 0”;
else c = b;

if (b) path_c[i] = c;
else path_c[i] = neg(c);
cmp_n_set_branch_hist(true);
i = i + 1;

The symbol p is a predicate to evaluate, b is the concrete value of the predicate in S, A is the symbolic state for primitives and P is the symbolic state for pointers.

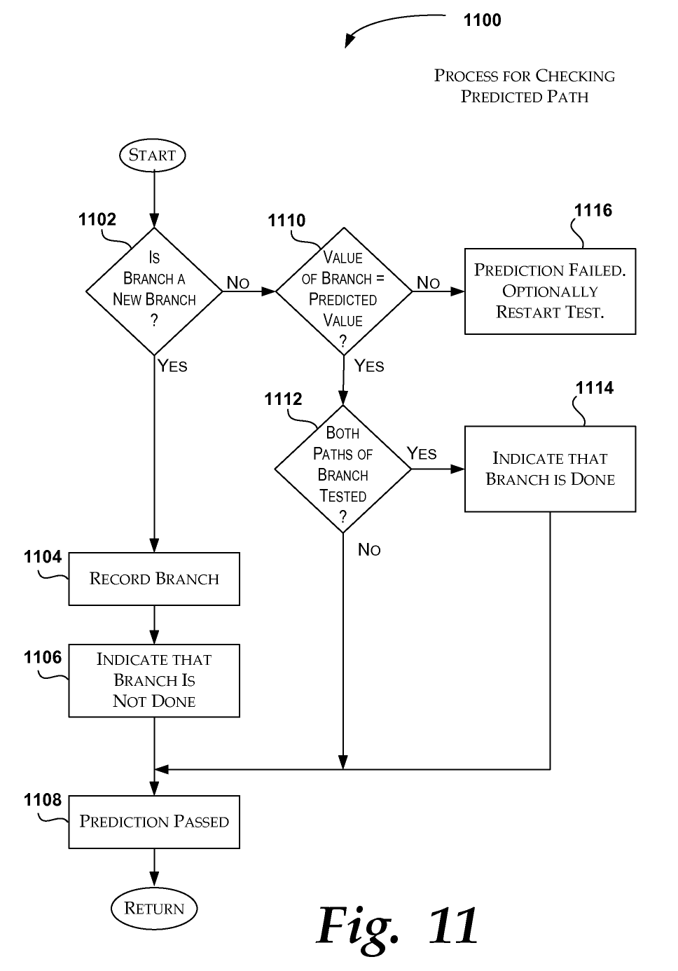

FIG. 11 is a flow diagram that illustrates one embodiment of a process for checking the predicted path which is suitable for use within the software testing process of FIG. 6. Process 1100 begins at decision block 1102 where a determination is made whether the current branch is a new branch that is being traversed. If the current branch is a new branch, processing continues at block 1104.

At block 1104, the new branch is recorded in the branch history. As mentioned above, the branch history may be maintained for each iteration so that the testing technique can determine when all the branches have been tested. Processing continues at block 1106.

At block 1106, the branch history for the branch may be set to indicate that this testing of this branch is done. This information will be used when that last constraint can not be negated. When that occurs, back tracking checks which branches are done in order to locate a constraint that should be negated. This will be explained later in conjunction with FIG. 12 on constraint solving. Processing continues at block 1108.

At block 1108, an indication that the prediction passed is relayed back to processing within FIG. 6. This will indicate to process 600 that the prediction was satisfied and that normal processing may continue.

If the current branch is not a new branch at decision block 1102, processing continues at decision block 1110 where the branch is compared with the predicted branch. In one embodiment, each branch may be represented with a true/false, and be indexed such that the first conditional corresponds to index 0, the second conditional corresponds to index 1, and so on. The comparison then compares the true/false value of the current branch with the true/false value in the predicted path. If the comparison passes, processing continues at decision block 1112.

At decision block 1112, a determination is made whether both paths of the branch have been tested. Once both paths of the branch have been tested, the software testing technique no longer needs to test this branch. This eliminates the redundant testing of branches. If both paths have not been tested, processing continues at block 1108. If both paths have been tested, processing continues at block 1114 where an indication that the branch is done is set. Processing continues at block 1108 which informs process 600 of a successful prediction.

In the event that the current branch does not match the predicted path, processing continues at block 1116. At block 1116, an indication that a prediction failed may be provided. In addition, process 600 may be restarted. This allows new test values to be input which will hopefully not results in the same failure.

FIG. 12 is a flow diagram that illustrates one embodiment of a process 1200 for solving constraints and determining a new logical input map which is suitable for use within the software testing process of FIG. 6. Process 1200 utilizes and builds upon a conventional constraint solver for linear arithmetic constraints, such as the well known constraint solver lp_solve. Process 1200 begins at decision block 1202, where a determination is made whether the last constraint should be syntactically negated. As long as both outcomes of the constraint have not been performed, the last constraint should be negated. If the last constraint can be syntactically negated, the solver does not need to invoke the expensive semantic check (block 1220). Experimental results show that this optimization reduces the number of semantic checks by 60-95%. However, if the last constraint can not be negated, processing proceeds to block 1220. Otherwise, processing continuing at block 1204.

At block 1204, the last constraint is negated. At block 1206, the set of predicates then includes the negated constraint. Processing continues at decision 1208 in order to compute a new input graph.

At block 1208, a determination is made whether the set of predicates are linear arithmetic predicates or pointers. If the set of predicates are pointers, processing continues at block 1214. If the set of predicates are linear arithmetic predicates, processing continues at block 1210.

At block 1210, a conventional linear technique may be performed to compute the new logical input map. Process 1200 is then complete.

At block 1214, a pointer technique is used to compute the new logical input map in accordance with one embodiment of the present software testing technique. The pointer technique is described below in conjunction with FIG. 13. After the new logical input map is computed, the constraint solving process is complete.

However, as mentioned above, if the last constraint should not be negated, then a semantic check must be performed to locate the last unnegated constraint. At block 1220, the last unnegated constraint is obtained. This is achieved by back tracking up the path constraint to determine a constraint which should be negated. In one embodiment, a backtrack indicator associated with each branch is modified to indicate that the entire branch has been tested. Once a constraint is identified, processing continues at block 1222.

At block 1222, common arithmetic sub-constraints are identified and removed. Thus, the solver identifies and eliminates common arithmetic sub-constraints before passing them to lp_solve. Processing continues at block 1224.

At block 1224, a set of predicates in the current path constraint are obtained that are dependent on the negated current path. By identifying these dependencies, the dependencies can be exploited in order to solve the constraints faster and keep the solutions similar. This optimization, along with block 1222, has shown a significant reduction in the number of sub-constraints, such as a 64% to 90% reduction. This allows the constraints to be solved faster and the solutions to be kept similar. The set is determined on the following observation. Given a predicate p in C, vars(p) may be defined to be the set of all symbolic variables that appear in p. Given two predicates p and p′ in C, p and p′ are dependent if one of the following conditions holds: 1) the intersection of the set of all symbolic variables in p with the set of all symbolic variables in p′ is not zero; or 2) there exists a predicate p″ in C such that p and p″ are dependent and p′ and p″ are dependent. Two predicates are independent if the predicates are not dependent.

The following observation allows the constraint solver in the present software testing technique the ability to solve constraints efficiently and in an incremental manner. It was observed that the path constraints C and C″ from two consecutive execution iterations differ in a small number of predicates. In particular, they differ in the last predicate when there is not backtracking up the tree. Thus, their respective solutions for the logical input map I and I″ agree on many of their mappings.

By obtaining the set of predicates in C (the current path constraint) that are dependent on the negated current path, it was found that either all the predicates in the set were linear arithmetic predicates or pointer predicates, because no predicate in C contains both arithmetic symbolic pointers and pointer symbolic variables. Based on experimental results, the size of this set of predicates may be almost one-eighth the size of C on average. For example, if D represents the subset of predicates that are dependent on the negated current path, let D′ represents the subset of D that does not contain the predicate [symbol] path_c[j]. The solver first checks if [symbol] path_c[j] is consistent with the predicates in D. For this, the solver constructs an undirected graph whose nodes are the equivalence classes (with respect to the relation=) of all symbolic variables that appear in D′. The symbol [x]₌ denotes the equivalence class of the symbolic variable x. Given two nodes denoted by the equivalence classes [x]₌ and [y]₋, the solver adds an edge between [x]₌ and [y]₌ if and only if there exists symbolic variables u and v such that u≠v exists in D′ and uε[x]₌ and vε[y]₌. Given the graph, the solver finds that [symbol] path_c[j] is satisfiable if [symbol] path_c[j] is of the form x=y and there is no edge between [x]₌ and [y]₌ in the graph; otherwise, if [symbol] path_c[j] is of the form x≠y, then [symbol] path_c[j] is satisfiable if [x]₌ and [y]₌ are not the same equivalence class. If [symbol] path_c[j] is satisfiable, the solver computes the new logical input map according to block 1114. Processing then continues to decision block 1208 to determine how to find the new logical input map based on the set of dependent predicates as described above. However, this time each predicate in the set are evaluated.

FIG. 13 is a flow diagram that illustrates one embodiment of a “pointer” process 1300 for determining a new logical input map which is suitable for use within the process for solving constraints of FIG. 12. Process 1300 begins at decision block 1302 where a determination is made whether the constraint is in the form “x≠NULL”. If the constraint is in the form “x≠NULL”, processing continues at block 1304. Otherwise, processing continues at decision block 1306.

At block 1304, the “x” node is added to the current input graph. Adding a node may be implemented in several ways. In one embodiment, a node may be added by placing a pre-determined value, such as −1, in the corresponding address in the logical input map. Processing is then complete.

At decision block 1306, a determination is made whether the constraint is in the form of “x=NULL”. If the constraint is in the form “x=NULL”, processing continues at block 1308. Otherwise, processing continues at decision block 1310.

At block 1308, the “x” node is added to the current input graph. Processing is then complete.

At decision block 1310, a determination is made whether the constraint is in the form of “x=y”. If the constraint is in the form “x=y”, processing continues at block 1312. Otherwise, processing continues at decision block 1314.

At block 1312, the value stored for the aliased pointer is assigned the value of the aliased pointer in the current input graph. Processing is then complete.

At decision block 1314, a determination is made whether the constraint is in the form of “x≠y”. If the constraint is in the form “x≠y”, processing continues at block 1316. As mentioned above, the present software testing technique keeps the symbolic pointers simple. Therefore, the symbolic pointer will be one of the above four forms.

At block 1316, the aliased pointer is removed from the current input graph. Processing is then complete.

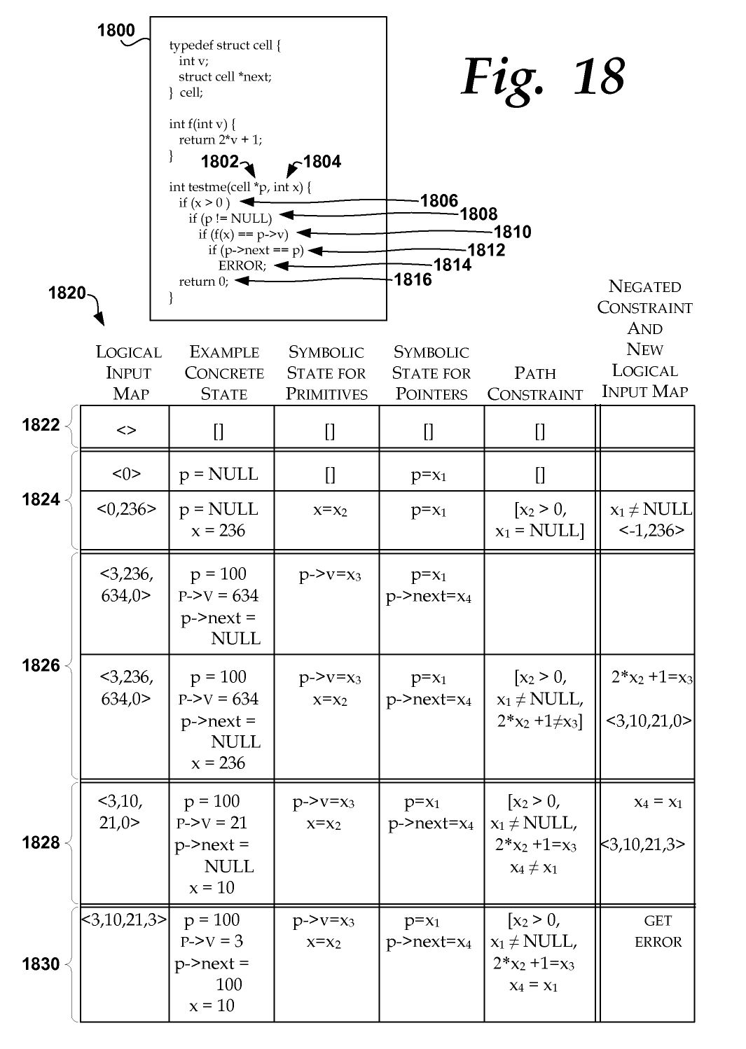

FIG. 18 is example code 1800 and runtime data 1820 that is generated during testing of code 1800 using the present software testing technique. Runtime data 1820 illustrates content within a logical input map (column 1), an example concrete state (column 2), an initial symbolic state for primitives (column 3), an initial symbolic state for pointers (column 4), a path constraint at the end of an iteration (column 5), and data of the negated constraint and the new logical input map after each of four iterations 1824, 1826, 1828, 1830 through code 1800. Determining the content within the runtime data 1820 will be explained using the process described above in FIGS. 6-12. In this embodiment, “0” refers to a NULL pointer value and “−1” refers to a non-NULL pointer value.

The software testing technique begins at block 602 in FIG. 6. At block 602, runtime data is initialized (represented as empty sets in each column of row 1822). Execution proceeds to block 604 where one iteration (e.g., iteration 1824) is performed concretely and symbolically. Although not shown, code 1800 has been instrumented with calls to library 304 as discussed above in conjunction with FIG. 5. The testme function is passed two inputs 1802 and 1804. The following example assumes the logical addresses within the logical input map begin at “1”. However, the logical addresses may begin at any number without departing from the present testing technique.

In iteration 1824, the first input parameter 1802 (i.e., cell p) is processed within block 606 as described in detail in conjunction with FIGS. 7 and 8. The logical address for cell p has not been defined (block 702) and is for a pointer (block 704). Therefore, the concrete state (i.e., p) is updated with a pre-determined value (e.g., NULL) at block 706. Correspondingly, column 2 in FIG. 18 indicates “p=NULL”. The logical address (i.e., 1) associated with p within the logical input map is updated with 0 at block 708 to indicate a NULL pointer. The logical input map in column 1 correspondingly indicates <0>. The symbolic state for pointers (block 712) is updated with p=x₁ as represented in column 4. For the present example, xₗ is used to represent a symbolic variable for logical address l.

Block 606 is then processed with the second input parameter 1804 (i.e., int x). Again, the logical address for int x has not been defined (block 702). However, this time, the input parameter is not a pointer so a random value is generated (block 720). At block 722, the logical address, now 2, is updated with the randomly generated value (e.g., 236). Thus, the logical input map in column 1 is now <0,236>. The concrete state (i.e., the physical address of x) is updated with the random value (block 724) as represented in column 2 with “x=236”. The symbolic state for primitives (block 726) is updated with x=x₂ as represented in column 3.

The next statement that is encountered is a conditional statement 1806 (i.e., if (x>0)). Therefore, block 610 is executed to evaluate the predicate (i.e., x>0) symbolically and to collect constraints in the path constraint. Referring to FIG. 10, the depth is within the bounded search (decision block 1002). The predicate (x>0) is an inequality (decision block 1004). At block 1006, a check is performed to determine whether x is in the symbolic state for primitives. Because 0 is a constant and not a variable, it cannot be in the symbolic state. As explained above, because the conditional is an inequality, the symbolic state for pointers need not be checked because pointer variables are either NULL or non-NULL. Since the inequality has only one variable, there is no need to check both variables. For x and 0, x is replaced with x₂ and the computed constraint (block 1008) is x₂−0>0 or x₂>0. At decision block 1018, the concrete value of the predicate is true because 236 is greater than 0. Therefore, x₂>0 is added to the current path constraint (block 1020) as shown in column 5 for iteration 1824. Processing of the conditional (block 610) is thereby completed. At decision block 612, the current execution path is compared with the predicted path. The comparison is shown in FIG. 11. However, because this is the first iteration, the branch is a new branch (decision block 1102). Therefore, the comparison (block 1110) is skipped and instead the sequence of branches for this iteration is built by recording the branch (block 1104). At block 1106, the branch is set to indicate that it is not done. At block 1108, the prediction passes and returns to block 604 to continue processing of the next statement.

The next statement that is encountered is another conditional (i.e., p !=NULL) statement 1808. Block 610 is executed as illustrated in FIG. 10. The predicate is a disequality (decision block 1010) where the first variable, symbolic variable x₁ for p, is in the symbolic state for pointers and the second is a constant (block 1012). The computed constraint is then x₁ !=NULL (block 1014). However, because the concrete value of this predicate is FALSE (decision block 1018), the current path constraint is set as the negated computed constraint (block 1024). Thus, x₁==NULL is added to the path constraint as shown in column 5 for iteration 1824.

From conditional (p !=NULL), the then branch is taken. The next statement that is encountered is “return 0”, statement 1816. However, in addition to executing that statement, the constraint solver (block 614) is run. As shown in FIG. 12, the constraint solver attempts to negate the constraint that corresponds to the last branch that did not have both of its paths already tested. The branch history is checked from the last constraint added to the first constraint that was added. The last constraint that was added in this example was x₁==NULL. Therefore, at block 1202, a check is performed to see whether the negation of x₁==NULL should be performed. If the negation has already been tested, the testing technique does not test the same branch. For this example, x₁ !=NULL has not been tested. At block 1204, the last constraint is negated. At block 1206, the set of predicates includes the negated current path yields x₁ !=NULL. At decision block 1208, the set is not linear arithmetic predicates, so the pointer technique in block 1214 is performed to compute the new input graph. Turning to FIG. 13, at decision block 1302, the constraint is a disequality, processing continues at block 1304 where the node is added to the current input graph. Adding a node may be implemented in several ways. For this example, a node is added by placing a −1 in the corresponding address in the logical input map. Thus, the new logical input map is now <−1,236>. As mentioned above, in one embodiment, a −1 indicates a non-NULL pointer.

The second iteration 1826 is then started. The symbolic states and concrete state are cleared (block 618). The new logical input map is used to translate the values into the concrete state and to create the symbolic states. In iteration 1826, the first input parameter 1802 (i.e., cell p) is processed within block 606 as described in detail in conjunction with FIGS. 7 and 8. This time the logical address for cell p has been defined (block 702) and is for a pointer (block 730). Therefore, processing to handle a pointer input graph is performed (block 740) as illustrated in FIG. 8. Pointer cell p has not been allocated memory (decision block 802) and memory should be allocated (decision block 804). One can determine that memory should be allocated by the value stored in the corresponding logical address for the pointer. In the above example, having a value of −1 indicates that the solver expects this pointer to be non NULL. Therefore, memory needs to be allocated. At block 806, the number of fields associated with cell p are obtained. The number of fields are 2: one for “int v” and one for “struct cell *next”. Memory is allocated for each field (block 808). This example uses memory addresses 100 and 102 to correspond to the address for the two fields, respectively. At block 810, the address of the first allocated field is stored for the pointer. Thereby, updating the concrete state for the pointer p to be a value of 100, as illustrated in column 2 with “p=100”. At block 812, the next logical address is calculated. This calculation adds one to the last logical address in the logical input map. This allows the logical input map to expand to accommodate the new variables. In this example, the last logical address is 2. Therefore, the next logical address is 3. At block 814, the calculated value for the next logical address is stored in the logical input map at the current logical address (i.e., 1), thus linking the pointer to its first field. This is represented in column 1 by a value of 3 as the first entry in the logical input map. At block 816, process 700 is recursively called for each field. In summary, because the first field (int v) is not a pointer, a random value (e.g., 634) is generated and stored in the logical input map at address 3 and because the second field (struct cell *next) is a pointer, address 4 is set to NULL as represented in column 1 by <3,236,634,0> for the logical input map. In addition, the concrete state is updated with these values as shown in column 2 and the symbolic states are updated as shown in column 3 and 4.

Block 606 is then processed with the second input parameter 1804 (i.e., int x). Because the logical address for int x has been defined (decision block 702) and is not for a pointer (decision block 730), the value associated with the logical address is obtained from the logical input map (block 732). This value is then used to update the concrete state as represented by adding “x=236” in column 2. In addition, the symbolic state for the primitives is updated with x=x₂ as in column 3.

The next statement that is encountered is the conditional statement 1806 (i.e., if (x>0)). Therefore, block 610 is executed to evaluate the predicate (i.e., x>0) symbolically and to collect constraints in the path constraint. This results in x₂>0 being added to the current path constraint as shown in column 5 for iteration 1826. The prediction at decision block 612 passes and returns to block 604 where the next statement is processed.

The next statement that is encountered is another conditional (i.e., p !=NULL). Block 610 is executed as illustrated in FIG. 10. The predicate is a disequality (decision block 1010) where the first variable p is in the symbolic state for pointers and the second variable, NULL, is a constant. The computed constraint is then x₁ !=NULL (block 1014). However, in contrast with iteration 1824, this time, the concrete value of this predicate is TRUE (decision block 1018). Therefore, the computed constraint is added to the current path constraint (block 1020). Thus, x₁ !=NULL is added to the path constraint as shown in column 5 for iteration 1826.

From conditional (p !=NULL), the “then” branch is taken. Conditional statement 1810 is encountered. Therefore, block 610 is executed to evaluate the predicate (i.e., f(x)==p−>v) symbolically and to collect constraints in the path constraint. Referring to FIG. 10, the depth is within the bounded search (decision block 1002). The predicate (f(x)==p−>v) is an equality (decision block 1010). The expression f(x) is computed through an inter-procedural dynamic tracing of symbolic expressions which results in 2·x₂+1. At block 1012, p−>v is checked to determine whether p−>v is in the symbolic state for primitives or pointers. It is found that p−>v has an entry in the symbolic state for pointers and the computed constraint (block 1014) is 2·x₂+1=x₃. At decision block 1018, the concrete value of the predicate is false because (2·236)+1!=634. Therefore, the negated computed constraint (i.e., 2·x₂+1!=x₃) is added to the path constraint as shown in column 5 of iteration 1826. Returning to FIG. 6, at decision block 612, the current execution path is compared with the predicted path. Referring to FIG. 11, the branch is a new branch (decision 1102), therefore the branch is recorded (block 1104) and indicated as not done (block 1106). The success of the prediction (block 1108) is returned to decision block 612. Processing then continues with the next statement.

The next statement that is encountered is the “return 0”, statement 1816. However, in addition to executing that statement, the constraint solver (block 614) is run. As shown in FIG. 12, the constraint solver attempts to negate the constraint that corresponds to the last branch that was not done. The branch history is checked from the last constraint added to the first constraint that was added. The last constraint that was added in this example was 2·x₂+1!=x₃. Therefore, at block 1202, a check is performed to see whether the negation of 2·x₂+1!=x₃ should be performed. If the negation has already been tested, the testing technique does not test the same branch. For this example, 2·x₂+1=x₃ has not been tested. At block 1204, the last constraint is negated. At block 1206, the set of predicates is set to include the negated current path which yields 2·x₂+1=x₃.

At decision block 1208, it is determined that the predicates in the set are linear arithmetic predicates. Interestingly, even though x₃ is referenced by a pointer, the actual variable is a primitive and not a pointer. Thus, as shown in column 3, x₃ is listed within the symbolic state for primitives. At block 1210, a new input graph is computed using a linear technique. The linear technique attempts to find a solution where 2·x₂+1=x₃. Multiple solutions may be found. For this example, x₂ is set to a value of 10 and x₃ is set to a value of 21. Thus, the new logical input map in column 6 now is <3,10,21,0>. One will note that the specific value for x₂ has changed, but the value remains in the same equivalence class with respect to the predicate where it appears, namely x₂>0. Processing returns to FIG. 6 to test another feasible path (decision block 616).

The third iteration 1828 is then started. The symbolic states and concrete state are cleared (block 618). The new logical input map is used to translate the values into the concrete state and to create the symbolic states. In iteration 1828, the first input parameter 1802 (i.e., cell p) is processed within block 606. This time the logical address for cell p has been defined (block 702) and is for a pointer (block 730). Therefore, processing to handle a pointer input graph is performed (block 740) as illustrated in FIG. 8. This time, however, pointer cell p has been allocated memory (decision block 802) as indicated by a positive integer (i.e., 3) at the corresponding logical address in the logical input map. The value represents the logical address within the logical input map associated with the first field. Therefore, the concrete state and symbolic states need to be updated for each field of the pointer. At block 822, the logical address is set to correspond with the logical address associated with the first field. Thus, the logical address is set to 3.

At block 816, for each field, process 700 is recursively called to update the concrete state and a symbolic state associated with each field based on the logical input map. In summary, for p−>v, the logical address for 3 is defined (decision block 702), is not for a pointer (decision block 730), therefore, the value (i.e., 21) is obtained from the logical input map. The concrete state for the first field (p−>v) is set to this value as represented in column 2 for iteration 1828. In addition, a symbolic variable (i.e., p−>v=x₃) is added to the symbolic state for primitives as represented in column 3. Processing returns to block 816 to process the second field (i.e., struct cell *next). The logical address is incremented to 4. The logical address is defined (decision block 702) and is for a pointer (decision block 730). Thus, processing proceeds to block 740 where the pointer input graph is handled. Referring to FIG. 8, at decision block 802 memory has not been allocated. At decision block 804, memory should not be allocated because the NULL within the logical input map indicates that the constraint solver has not identified a constraint that requires the pointer to be non-NULL. Therefore, at block 818, the concrete state for p−>next is set to NULL as represented in column 2 for iteration 1828. In addition, symbolic expression p−>next=x₄ is added to the symbolic state for pointers as shown in column 4.

Block 606 is then processed with the second input parameter 1804 (i.e., int x). Because the logical address for int x has been defined (decision block 702) and is not for a pointer (decision block 730), the value associated with the logical address is obtained from the logical input map (block 732). This value is then used to update the concrete state as represented by adding “x=10” in column 2. In addition, the symbolic state for primitives is updated with x=x₂ as shown in column 3.

The next statement that is encountered is a conditional statement 1806 (i.e., if (x>0)), resulting in x₂>0 being added to the current path constraint as shown in column 5 for iteration 1828, as explained above. At decision block 612, the current execution path is compared with the predicted path. This proceeds as described above and returns to block 604 where the next statement is processed.

The next statement that is encountered is another conditional (i.e., p !=NULL). Block 610 is executed as illustrated in FIG. 10. This proceeds as described above, resulting in the computed constraint being added to the current path constraint (block 1020). Thus, x₁ !=NULL is added to the path constraint as shown in column 5 for iteration 1828.

From conditional (p !=NULL), the then branch is taken. Conditional statement 1810 is encountered. Therefore, block 610 is executed to evaluate the predicate (i.e., f(x)==p−>v) symbolically and to collect constraints in the path constraint. As described above, the computed constraint (i.e., 2·x₂+1=x₃) is added to the path constraint as shown in column 5 of iteration 1828. Returning to FIG. 6, at decision block 612, the current execution path is compared with the predicted path. There is no new branch (decision block 1102), the value of the branch is the predicted value (decision block 1110), and both paths have now been tested (decision block 1112). Therefore, this branch (i.e., f(x)==p−>v) is indicated as done. The success of the prediction (block 1108) is returned to decision block 612. Processing then continues with the next statement.

From conditional (f(x)==p−>v), the if branch is taken. Conditional statement 1812 is encountered. Therefore, block 610 is executed to evaluate the predicate (i.e., p−>next==p) symbolically and to collect constraints in the path constraint. Referring to FIG. 10, the depth is within the bounded search (decision block 1002). The predicate (p−>next==p) is an equality (decision block 1010). At block 1012, p−>next and p are checked to determine whether they have corresponding entries in the symbolic state for primitives or pointers. Both have entries (i.e., p−>next=x₄ and p=x₁, respectively). The computed constraint (block 1014) is x₄=x₁. At decision block 1018, the concrete value of the predicate (i.e., NULL==3) is false. Therefore, the negated computed constraint (i.e., x₄ !=x₁) is added to the path constraint (block 1024 as shown in column 5 of iteration 1828. Returning to FIG. 6, at decision block 612, the current execution path is compared with the predicted path. There is a new branch (decision block 1102). Therefore, the new branch is recorded (block 1104), the branch is indicated as done (block 1106), and the success of the prediction (block 1108) is returned to decision block 612.

From conditional (p−>next==p), the else branch is taken. The next statement that is encountered is “return 0”, statement 1816. The constraint solver (block 614) is run. Referring to FIG. 12, the last constraint that was added in this example was x₄ !=x₁. Therefore, at block 1202, a check is performed to see whether the negation of x₄ !=x₁ should be performed. If the negation has already been tested, the testing technique does not test the same branch. For this example, x₄=x₁ has not been tested. At block 1204, the last constraint is negated. At block 1206, the set of predicates includes the negated last constraint x₄=x₁. At decision block 1208, it is determined that the predicates in the set are not linear arithmetic predicates. Therefore, the pointer technique illustrated in FIG. 13 is used to compute the new input graph. The constraint is an equality between two pointers (decision block 1310). Therefore, one of the values stored for the aliased pointer is assigned to both pointers in the current input graph. This results in both logical address 1 and logical address 4 being assigned a value of 3 in the new logical input map, as indicated in column 6 by <3,10,21,3>. The value of 3 is used instead of NULL otherwise logical address 1 would be unable to maintain its link to its fields. Processing returns to FIG. 6 to test another feasible path (decision block 616). Thus, the above path constraint includes dynamically obtained constraints on pointers. As shown, the present testing technique handles constraints on pointers but does not require static alias analysis.

The fourth iteration 1830 is then started. The symbolic states and concrete state are cleared (block 618). The new logical input map is used to translate the values into the concrete state and to create the symbolic states. This proceeds in the same manner as iteration 1828, until conditional statement 1812 is encountered.

For conditional statement 1812, block 610 is executed to evaluate the predicate (i.e., p−>next==p) symbolically and to collect constraints in the path constraint. Referring to FIG. 10, the depth is within the bounded search (decision block 1002). The predicate (p>next==p) is an equality (decision block 1010). At block 1012, p−>next and p are checked to determine whether they have corresponding entries within the symbolic state for primitives or pointers. Both have corresponding entries (i.e., p−>next=x₄ and p=x₁, respectively). The computed constraint (block 1014) is x₄=x₁. At decision block 1018, the concrete value of the predicate is true because 3=3. Therefore, the computed constraint (i.e., x₄=x₁) is added to the current path constraint as shown in column 5 of iteration 1830. Returning to FIG. 6, at decision block 612, the current execution path is compared with the predicted path. There is no new branch (decision block 1102), the value of the branch equaled the predicted value (decision block 1110), and both paths of the branch have been tested (decision block 1114). Therefore, the branch is indicated as “done” (block 1118). The success of the prediction (block 1108) is returned to decision block 612. From conditional (p−>next==p), the if branch (statement 1814) is taken, where an error in code 1800 occurs. This error may then be identified so that code 1800 can be corrected.

Thus, as described above, the present software testing technique represents inputs for the unit under test using a logical input map that represents all inputs, including (finite) memory graphs, as a collection of scalar symbolic variables. During concrete execution using these inputs, constraints are collected on these inputs by symbolically executing the instrumented code simultaneously with the concrete execution. The pointer constraints are conceptually simplified by using the logical input map to replace complex symbolic expressions involving pointers with simple symbolic pointer variables, while maintaining the precise pointer relations in the logical input map.

The present software testing technique can explore the feasible execution paths for the instrumented code. As described above, it can test functions that take data structures as inputs. In other words, the function has one or more pointer variables and the memory graph reachable from the pointers form a data structure. There are two main approaches to obtaining valid inputs: 1) generating inputs with call sequences; or 2) solving data structure invariants. The present software testing technique supports both approaches. This testing technique has been successful at finding several errors, some errors occurred in code used in commercial tools.

While example embodiments and applications have been illustrated and described, it is to be understood that the invention is not limited to the precise configurations and resources described above. Various modifications, changes, and variations apparent to those skilled in the art may be made in the arrangement, operation, and details of the disclosed embodiments herein without departing from the scope of the claimed invention.

What is claimed is:

1. At least one computer-readable media storing computer-executable instructions for performing a method for testing a software program, the method comprising:
iteratively executing an instrumented unit of code of the software program using different input values to the instrumented unit of code on each execution iteration, wherein the instrumented unit of code is iteratively executed using concrete execution and symbolic execution, each different input value being associated with a logical address; and
maintaining a logical input map that is used in determining the different input values based on the associated logical address, the logical input map providing a mechanism for maintaining a precise pointer relationship between a pointer and an associated field of the pointer.

2. The computer-readable media of claim 1, wherein the mechanism for maintaining a precise pointer relation comprises:
storing the logical address associated with a first field of the pointer in the logical address associated with the pointer.

3. The computer-readable media of claim 1, wherein determining the input value for each input comprises randomly generating the input value if the logical address is associated with a non-pointer and has not been previously defined.

4. The computer-readable media of claim 3, further comprising storing the input value at a physical address associated with the input and adding a symbolic variable within a symbolic state for primitives.

5. The computer-readable media of claim 1, wherein determining the input value for each input comprises setting the input value to a pre-determined value if the logical address is associated with the pointer and has not been previously defined.

6. The computer-readable media of claim 5, wherein the pre-determined value comprises NULL.

7. The computer-readable media of claim 5, further comprising storing the value at a physical address associated with the pointer and adding a symbolic variable within a symbolic state for pointers.

8. The computer-readable media of claim 1, wherein the mechanism for maintaining the precise pointer relation comprises:
allocating memory for the pointer based on a type for the pointer;
randomly generating a value for each field of the pointer that represents a primitive;
setting each field of the pointer that represents another pointer to a pre-determined value; and
updating the logical input map for each field of the pointer.

9. The computer-readable media of claim 1, wherein symbolic execution comprises collecting constraints associated with one execution iteration that defines a path constraint associated with that one execution iteration.

10. The computer-readable media of claim 9, wherein symbolic execution further comprises negating one of the constraints within the path constraint to define a predicted path.

11. The computer-readable media of claim 10, further comprising stopping the iterative execution of the instrumented unit of code if the path constraint obtained during a subsequent iteration does not match the predicted path.

12. The computer-readable media of claim 1, further comprising stopping the iterative execution of the instrumented unit of code when testing indicates that each execution path of the instrumented unit of code has been tested.

13. The computer-readable media of claim 1, further comprising:
collecting constraints for a plurality of symbolic expressions and a plurality of pointer symbolic variables; and
solving the constraints to incrementally generate one set of the different input values and storing that set in the logical input map for the next iteration.

14. A computer-implemented method comprising:
symbolically executing an instrumented unit of code to collect a plurality of primitive symbolic variables and a plurality of pointer symbolic variables, each primitive symbol being associated with one of a plurality of variables within the instrumented unit of code and each pointer symbol being associated with one of a plurality of pointers within the instrumented unit of code; and
storing the plurality of pointer symbolic variables in a manner that maintains the relation between one of the plurality of pointers and a field associated with the one pointer.

15. The computer-implemented method of claim 15, wherein the field comprises a variable.

16. The computer-implemented method of claim 15, wherein the field comprises a pointer.

17. The computer-implemented method of claim 15, further comprising determining a value for the field based on whether the field is associated with a pointer or a non-pointer.

18. The computer-implemented method of claim 17, wherein if the field is associated with a non-pointer, storing a randomly generated value upon an initial encounter with the field.

19. The computer-implemented method of claim 18, wherein if the field is associated with a pointer, storing a pre-determined value upon an initial encounter with the pointer.

20. The computer-implemented method of claim 18, wherein storing the plurality of pointer symbolic variables in a manner that maintains the relation comprises:
storing the logical address associated with a first field of the pointer in the logical address associated with the pointer.

21. A system, comprising:
a processor; and
a memory into which a plurality of instructions are loaded, the plurality of instructions testing a portion of a software program when executed by the processor, the system, when executing the instructions, being configured to:
iteratively execute an instrumented unit of code of the software program using different input values to the instrumented unit of code on each execution iteration, wherein the instrumented unit of code is iteratively executed using concrete execution and symbolic execution, each different input value being associated with a logical address; and
maintain a logical input map that is used in determining the different input values based on the associated logical address, the logical input map providing a mechanism for maintaining a precise pointer relation between a pointer and an associated field of the pointer.
